(19) United States
(12) Patent Application Publication
(10) Pub. No.: US 2006/0195315 A1
(43) Pub. Date: Aug. 31, 2006

(54) Sound synthesis processing system

(75) Inventors: Yasushi Sato, Fukuoka-shi (JP); Hiroaki Kojima, Tsukuba-shi (JP); Kazuyo Tanaka, Tsukuba-shi (JP)

Correspondence Address: ERIC ROBINSON, PMB 955, 21010 SOUTHBANK ST., POTOMAC FALLS, VA, 20165, US

(73) Assignees: Kabushiki Kaisha Kenwood, Tokyo (JP); National Institute of Advanced Industrial Science and Technology, Tokyo (JP)

(21) Appl. No.: 10/546,072

(22) PCT Filed: Feb. 17, 2004
(86) PCT No.: PCT/JP04/01712

§ 371 Date: Aug. 17, 2005

(30) Foreign Application Priority Data
Feb. 17, 2003 (JP) 2003-038738
Feb. 16, 2004 (JP) 2004-038858

(51) Int. Cl. G10L 11/04

(52) U.S. Cl. 704/207

(57) ABSTRACT

To provide a pitch waveform signal division device and the like for making it possible to compress a data capacity of data representing a sound efficiently. A computer C1 arranges time lengths of sections for a unit pitch of sound data, which the computer C1 compresses, to be identical to thereby generate a pitch waveform signal, detects a boundary of adjacent phonemes included in a sound represented by the pitch waveform signal and an end of this sound on the basis of intensity of a difference between two sections for adjacent unit pitches of this pitch waveform signal, divides the pitch waveform signal in the detected boundary and end, and outputs obtained data as phoneme data.

### TECHNICAL FIELD

The present invention relates to a pitch waveform signal division device, a sound signal compression device, a database, a sound signal restoration device, a sound synthesis device, a pitch waveform signal division method, a sound signal compression method, a sound signal restoration method, a sound synthesis method, a recording medium, and a program.

### BACKGROUND ART

In recent years, methods of sound synthesis for converting text data and the like into sounds have been performed in the fields of car navigation and the like.

In the sound synthesis, for example, words, clauses, and modification relations among the clauses included in a sentence represented by text data are specified and reading of the sentence is specified on the basis of the specified words, clauses, and modification relations. A waveform and a duration of a phoneme and a pattern of a pitch (a basic frequency) constituting a sound are determined on the basis of a phonogram string representing the specified reading. A waveform of a sound representing an entire kanji-kana-mixed sentence is determined on the basis of a result of the determination. A sound having the determined waveform is outputted.

In the method of sound synthesis described above, in order to specify a waveform of a sound, a sound dictionary, in which sound data representing the waveform of the sound are accumulated, is searched through. In order to make a sound to be synthesized natural, an enormous number of sound data have to be accumulated in the sound dictionary.

In addition, when this method is applied to an apparatus required to be reduced in size such as a car navigation apparatus, in general, it is also necessary to reduce a size of a storage that stores a sound dictionary used by the apparatus. If the size of the storage is reduced, in general, a reduction in a storage capacity thereof is inevitable.

Thus, in order to allow a storage with a small capacity to store a phoneme dictionary including a sufficient quantity of sound data, data compression is applied to sound data to reduce a data capacity for one piece of sound data (see, for example, a published Japanese translation of a National Publication of International Patent Application No. 2000-502539).

However, in compressing sound data representing a sound uttered by a human using a method of entropy coding (specifically, arithmetic coding, Huffman coding, etc.) that is a method of compressing data paying attention to regularity of data, since the sound data as a whole does not always have clear periodicity, efficiency of compression is low.

A waveform of a sound uttered by a human consists of, for example, as shown in FIG. 17(a), sections of various time lengths with regularity, sections without clear regularity, and the like. Therefore, efficiency of compression falls when entire sound data representing the sound uttered by a human is subjected to entropy coding.

When sound data is delimited at each fixed time length to subject the delimited sound data to the entropy coding, for example, as shown in FIG. 17(b), usually, delimit timing (timing indicated as “T1” in FIG. 17(b)” does not coincide with a boundary of adjacent two phonemes (timing indicated as “T0” in FIG. 17(b)). Consequently, it is difficult to find out regularity common to all of the respective delimited portions (e.g., portions indicated as “P1” or “P2” in FIG. 17(b)). Therefore, efficiency of compression of these respective portions is also low.

Fluctuation in a pitch is also a problem. A pitch is susceptible to human feeling and consciousness. Although the pitch is a period that can be regarded as fixed to some extent, actually, fluctuation occurs in the pitch subtly. Therefore, when an identical speaker utters the same words (phonemes) for plural pitches, intervals of the pitches are not fixed usually. Therefore, accurate regularity is not observed in a waveform representing one phoneme in many cases. Consequently, efficiency of compression by the entropy coding is often low.

The invention has been devised in view of the actual circumstances described above and it is an object of the invention to provide a pitch waveform signal division device, a pitch waveform signal division method, a recording medium, and a program for making it possible to efficiently compress a data capacity of data representing sound.

It is another object of the invention to provide a sound signal compression device and a sound signal compression method for efficiently compressing a data capacity of data representing sound, a sound signal restoration device and a sound signal restoration method for restoring the data compressed by the sound signal compression device and the sound signal compression method, a database and a recording medium for holding the data compressed by the sound signal compression device and the sound signal compression method, and a sound synthesis device and a sound synthesis method for performing sound synthesis using the data compressed by the sound signal compression device and the sound signal compression method.

### DISCLOSURE OF THE INVENTION

To achieve the above described objects, a first aspect of the present invention provides a pitch waveform signal division device comprising:

a filter for acquiring a sound signal representing a waveform of sound and filtering the sound signal to extract a pitch signal;

phase adjusting means for delimiting the sound signal into sections based on the pitch signal extracted by the filter and adjusting the phase for each section based on the correlation between the section and the pitch signal;

sampling means for determining a sampling length for each section with the phase adjusted by the phase adjusting means, based on the phase, and performing sampling with the sampling length to generate a sampling signal;

sound signal processing means for processing the sampling signal into a pitch waveform signal based on the result of the adjustment by the phase adjusting means and the value of the sampling length; and

pitch waveform signal dividing means for detecting a boundary of adjacent phonemes included in the sound represented by the pitch waveform signal and/or an end of the sound, and dividing the pitch waveform signal at the detected boundary and/or end.

The pitch waveform signal dividing means may determine whether the intensity of the difference between two adjacent sections for a unit pitch of the pitch waveform signal is a predetermined amount or more, and if it is determined to be the predetermined amount or more, then it may detect the boundary between the two sections as a boundary of adjacent phonemes or an end of sound.

The pitch waveform signal dividing means may determine whether the two sections represent fricative based on the intensity of a portion of the pitch signal belonging to the two sections, and if it is determined that they represent fricative, then it may determine that the boundary of the two sections is not a boundary of adjacent phonemes or an end of sound regardless of whether the intensity of the difference between the two sections is the predetermined amount or more.

The pitch waveform signal dividing means may determine whether a portion of the pitch signal belonging to the two sections is a predetermined amount or less, and if it is determined to be the amount or less, then it may determine that the boundary of the two sections is not a boundary of adjacent phonemes or an end of sound regardless of whether the intensity of the difference between the two sections is the predetermined amount or more.

A second aspect of the present invention provides a pitch waveform signal division device comprising:

sound signal processing means for acquiring a sound signal representing a waveform of sound, and processing the sound signal into a pitch waveform signal by substantially equalizing the phases of sections where the sound signal is divided into the sections for a unit pitch of the sound; and

pitch waveform signal dividing means for detecting a boundary of adjacent phonemes included in the sound represented by the pitch waveform signal and/or an end of the sound, and dividing the pitch waveform signal at the detected boundary and/or end.

A third aspect of the present invention provides a pitch waveform signal division device comprising:

means for detecting, for pitch waveform signal representing a waveform of sound, a boundary of adjacent phonemes included in the sound represented by the pitch waveform signal and/or an end of the sound; and

means for dividing the pitch waveform signal at the detected boundary and/or end.

A fourth aspect of the present invention provides a sound signal compression device comprising:

a filter for acquiring a sound signal representing a waveform of sound and filtering the sound signal to extract a pitch signal;

phase adjusting means for delimiting the sound signal into sections based on the pitch signal extracted by the filter and adjusting the phase for each section based on the correlation between the section and the pitch signal;

sampling means for determining a sampling length for each section with the phase adjusted by the phase adjusting means, based on the phase, and performing sampling with the sampling length to generate a sampling signal;

sound signal processing means for processing the sampling signal into a pitch waveform signal based on the result of the adjustment by the phase adjusting means and the value of the sampling length;

phoneme data generating means for detecting a boundary of adjacent phonemes included in the sound represented by the pitch waveform signal and/or an end of the sound, and dividing the pitch waveform signal at the detected boundary and/or end to generate phoneme data; and

data compressing means for subjecting the generated phoneme data to entropy coding to perform data compression.

The pitch waveform signal dividing means may determine whether the intensity of the difference between two adjacent sections for a unit pitch of the pitch waveform signal is a predetermined amount or more, and if it is determined to be the predetermined amount or more, then it may detect the boundary between the two sections as a boundary of an adjacent phonemes or an end of sound.

The pitch waveform signal dividing means may determine whether the two sections represent fricative based on the intensity of a portion of the pitch signal belonging to the two sections, and if it is determined that they represent fricative, then it may determine that the boundary of the two sections is not a boundary of adjacent phonemes or an end of sound regardless of whether the intensity of the difference between the two sections is the predetermined amount or more.

The pitch waveform signal dividing means may determine whether a portion of the pitch signal belonging to the two sections is a predetermined amount or less, and if it is determined to be the amount or less, then it may determine that the boundary of the two sections is not a boundary of adjacent phonemes or an end of sound regardless of whether the intensity of the difference between the two sections is the predetermined amount or more.

A fifth aspect of the present invention provides a sound signal compression device comprising:

sound signal processing means for acquiring a sound signal representing a waveform of sound, and processing the sound signal into a pitch waveform signal by substantially equalizing the phases of sections where the sound signal is divided into the sections for a unit pitch of the sound;

phoneme data generating means for detecting a boundary of adjacent phonemes included in the sound represented by the pitch waveform signal and/or an end of the sound, and dividing the pitch waveform signal at the detected boundary and/or end to generate phoneme data; and

data compressing means for subjecting the generated phoneme data to entropy coding to perform data compression.

A sixth aspect of the present invention provides a sound signal compression device comprising:

means for detecting, for pitch waveform signal representing a waveform of sound, a boundary of adjacent phonemes included in the sound represented by the pitch waveform signal and/or an end of the sound;

phoneme data generating means for dividing the pitch waveform signal at the detected boundary and/or end to generate phoneme data; and

data compressing means for subjecting the generated phoneme data to entropy coding to perform data compression.

The data compressing means may perform data compression by subjecting the result of nonlinear quantization of the generated phoneme data to entropy coding.

The data compressing means may acquire data-compressed phoneme data, determine a quantization characteristic of the nonlinear quantization based on the amount of the acquired phoneme data, and perform the nonlinear quantization in accordance with the determined quantization characteristic.

The sound signal compression device may further comprise means for sending the data-compressed phoneme data externally via a network.

The sound signal compression device may further comprise means for recording the data-compressed phoneme data into a computer readable recording medium.

A seventh aspect of the present invention provides a database for storing phoneme data, wherein the phoneme data is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound.

An eighth aspect of the present invention provides a database for storing phoneme data, wherein the phoneme data is acquired by dividing a pitch waveform signal representing a waveform of sound at a boundary of adjacent phonemes included in the sound represented by the pitch waveform signal and/or end of the sound.

A ninth aspect of the present invention provides a computer readable recording medium for storing phoneme data, wherein the phoneme data is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound.

A tenth aspect of the present invention provides a computer readable recording medium for storing phoneme data, wherein the phoneme data is acquired by dividing a pitch waveform signal representing a waveform of sound at a boundary of adjacent phonemes included in the sound represented by the pitch waveform signal and/or end of the sound.

The phoneme data may be subjected to entropy coding.

The phoneme data may be subjected to the entropy coding after being subjected to nonlinear quantization.

An eleventh aspect of the present invention provides a sound signal restoration device comprising:

data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound; and

restoring means for decoding the acquired phoneme data.

The phoneme data may be subjected to entropy coding, and

the restring means may decode the acquired phoneme data and restore the phase of the decoded phoneme data to the phase before the process.

The phoneme data may be subjected to the entropy coding after being subjected to nonlinear quantization, and

the restoring means may decode the acquired phoneme data and subjects it to the nonlinear quantization, and restore the phase of the phoneme data decoded and subjected to nonlinear quantization to the phase before the process.

The data acquiring means may acquire the phoneme data externally via a network.

The data acquiring means comprises means for acquiring the phoneme data by reading the phoneme data from a computer readable recording medium for recording the phoneme data.

A twelfth aspect of the present invention provides a sound synthesis device comprising:

data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound;

restoring means for decoding the acquired phoneme data;

phoneme data storing means for storing the acquired phoneme data or the decoded phoneme data;

sentence input means for inputting sentence information representing a sentence; and

synthesizing means for retrieving from the phoneme data storing means, phoneme data representing waveforms of phonemes composing the sentence, and combining the retrieved phoneme data pieces to generate data representing synthesized sound.

The sound synthesis device may further comprise:

sound piece storing means for phoneme data pieces representing sound pieces;

rhythm predicting means for predicting a rhythm of a sound piece composing an inputted sentence; and

selecting means for selecting from the sound data pieces, sound data that represents a waveform of a sound piece having the same reading as a sound piece composing the sentence and has a rhythm closest to the prediction result, and

the synthesizing means may comprise:

lacked part synthesizing means for retrieving from the phoneme data storing means, for a sound piece of which sound data has not been selectable by the selecting means among the sound pieces composing the sentence, phoneme data representing a waveform of phonemes composing the sound piece having not been selectable, and combining the retrieved phoneme data pieces to synthesize data representing the sound piece having not been selectable, and

means for generating data representing synthesized sound by combining the sound data selected by the selecting means and the sound data synthesized by the lacked part synthesizing means.

The sound piece storing means may store actual measured rhythm data representing temporal change in pitch of the sound piece represented by sound data, in correspondence with the sound data, and

the selecting means may select from the sound data pieces, sound data which represents a waveform having the same reading as a sound piece composing the sentence, the temporal change in pitch represented by the actual measured rhythm data in correspondence with the sound data being closest to the prediction result of rhythm.

The storing means may store phonogram data representing reading of sound data, in correspondence with the sound data, and

the selecting means may regard sound data in correspondence with phonogram data representing reading matching with that of a sound piece composing the sentence, as sound data representing a waveform of sound piece having the same reading as the sound piece.

The data acquiring means may acquire the phoneme data externally via a network.

The data acquiring means may comprise means for acquiring the phoneme data by reading the phoneme data from a computer readable recording medium for recording the phoneme data.

A thirteenth aspect of the present invention provides a pitch waveform signal division method comprising:

acquiring a sound signal representing a waveform of sound and filtering the sound signal to extract a pitch signal;

delimiting the sound signal into sections based on the extracted pitch signal and adjusting the phase for each section based on the correlation between the section and the pitch signal;

determining a sampling length for each section with the adjusted phase based on the phase, and performing sampling with the sampling length to generate a sampling signal;

processing the sampling signal into a pitch waveform signal based on the result of the adjustment by the phase adjusting means and the value of the sampling length; and

detecting a boundary of adjacent phonemes included in the sound represented by the pitch waveform signal and/or an end of the sound, and dividing the pitch waveform signal at the detected boundary and/or end.

A fourteenth aspect of the present invention provides a pitch waveform signal division method comprising:

acquiring a sound signal representing a waveform of sound, and processing the sound signal into a pitch waveform signal by substantially equalizing the phases of sections where the sound signal is divided into the sections for a unit pitch of the sound; and

detecting a boundary of adjacent phonemes included in the sound represented by the pitch waveform signal and/or an end of the sound, and dividing the pitch waveform signal at the detected boundary and/or end.

A fifteenth aspect of the present invention provides a pitch waveform signal division method comprising:

detecting, for pitch waveform signal representing a waveform of sound, a boundary of adjacent phonemes included in the sound represented by the pitch waveform signal and/or an end of the sound; and

dividing the pitch waveform signal at the detected boundary and/or end.

A sixteenth aspect of the present invention provides a sound signal compression method comprising:

acquiring a sound signal representing a waveform of sound and filtering the sound signal to extract a pitch signal;

delimiting the sound signal into sections based on the pitch signal extracted by the filter and adjusting the phase for each section based on the correlation between the section and the pitch signal;

determining a sampling length for each section with the adjusted phase based on the phase, and performing sampling with the sampling length to generate a sampling signal;

processing the sampling signal into a pitch waveform signal based on the result of the adjustment of the phase and the value of the sampling length;

detecting a boundary of adjacent phonemes included in the sound represented by the pitch waveform signal and/or an end of the sound, and dividing the pitch waveform signal at the detected boundary and/or end to generate phoneme data; and

subjecting the generated phoneme data to entropy coding to perform data compression.

A seventeenth aspect of the present invention provides a sound signal compression method comprising:

acquiring a sound signal representing a waveform of sound, and processing the sound signal into a pitch waveform signal by substantially equalizing the phases of sections where the sound signal is divided into the sections for a unit pitch of the sound;

detecting a boundary of adjacent phonemes included in the sound represented by the pitch waveform signal and/or an end of the sound, and dividing the pitch waveform signal at the detected boundary and/or end to generate phoneme data; and

subjecting the generated phoneme data to entropy coding to perform data compression.

An eighteenth aspect of the present invention provides a sound signal compression method comprising:

detecting, for pitch waveform signal representing a waveform of sound, a boundary of adjacent phonemes included in the sound represented by the pitch waveform signal and/or an end of the sound;

dividing the pitch waveform signal at the detected boundary and/or end to generate phoneme data; and

subjecting the generated phoneme data to entropy coding to perform data compression.

A nineteenth aspect of the present invention provides a sound signal restoration method comprising:

acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound; and

decoding the acquired phoneme data.

A twentieth aspect of the present invention provides a sound synthesis method comprising:

acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound;

decoding the acquired phoneme data;

storing the acquired phoneme data or the decoded phoneme data;

inputting sentence information representing a sentence; and

retrieving phoneme data representing waveforms of phonemes composing the sentence from the stored phoneme data, and combining the retrieved phoneme data pieces to generate data representing synthesized sound.

A twenty-first aspect of the present invention provides a program for making a computer act as:

a filter for acquiring a sound signal representing a waveform of sound and filtering the sound signal to extract a pitch signal;

phase adjusting means for delimiting the sound signal into sections based on the pitch signal extracted by the filter and adjusting the phase for each section based on the correlation between the section and the pitch signal;

sampling means for determining a sampling length for each section with the phase adjusted by the phase adjusting means, based on the phase, and performing sampling with the sampling length to generate a sampling signal;

sound signal processing means for processing the sampling signal into a pitch waveform signal based on the result of the adjustment by the phase adjusting means and the value of the sampling length; and

pitch waveform signal dividing means for detecting a boundary of adjacent phonemes included in the sound represented by the pitch waveform signal and/or an end of the sound, and dividing the pitch waveform signal at the detected boundary and/or end.

A twenty-second aspect of the present invention provides a program for making a computer act as:

sound signal processing means for acquiring a sound signal representing a waveform of sound, and processing the sound signal into a pitch waveform signal by substantially equalizing the phases of sections where the sound signal is divided into the sections for a unit pitch of the sound; and

pitch waveform signal dividing means for detecting a boundary of adjacent phonemes included in the sound represented by the pitch waveform signal and/or an end of the sound, and dividing the pitch waveform signal at the detected boundary and/or end.

A twenty-third aspect of the present invention provides a program for making a computer act as:

means for detecting, for pitch waveform signal representing a waveform of sound, a boundary of adjacent phonemes included in the sound represented by the pitch waveform signal and/or an end of the sound; and

means for dividing the pitch waveform signal at the detected boundary and/or end.

A twenty-fourth aspect of the present invention provides a program for making a computer act as:

a filter for acquiring a sound signal representing a waveform of sound and filtering the sound signal to extract a pitch signal;

phase adjusting means for delimiting the sound signal into sections based on the pitch signal extracted by the filter and adjusting the phase for each section based on the correlation between the section and the pitch signal;

sampling means for determining a sampling length for each section with the phase adjusted by the phase adjusting means, based on the phase, and performing sampling with the sampling length to generate a sampling signal;

sound signal processing means for processing the sampling signal into a pitch waveform signal based on the result of the adjustment by the phase adjusting means and the value of the sampling length;

phoneme data generating means for detecting a boundary of adjacent phonemes included in the sound represented by the pitch waveform signal and/or an end of the sound, and dividing the pitch waveform signal at the detected boundary and/or end to generate phoneme data; and

data compressing means for subjecting the generated phoneme data to entropy coding to perform data compression.

A twenty-fifth aspect of the present invention provides a program for making a computer act as:

sound signal processing means for acquiring a sound signal representing a waveform of sound, and processing the sound signal into a pitch waveform signal by substantially equalizing the phases of sections where the sound signal is divided into the sections for a unit pitch of the sound;

phoneme data generating means for detecting a boundary of adjacent phonemes included in the sound represented by the pitch waveform signal and/or an end of the sound, and dividing the pitch waveform signal at the detected boundary and/or end to generate phoneme data; and

data compressing means for subjecting the generated phoneme data to entropy coding to perform data compression.

A twenty-sixth aspect of the present invention provides a program for making a computer act as:

means for detecting, for pitch waveform signal representing a waveform of sound, a boundary of adjacent phonemes included in the sound represented by the pitch waveform signal and/or an end of the sound;

phoneme data generating means for dividing the pitch waveform signal at the detected boundary and/or end to generate phoneme data; and

data compressing means for subjecting the generated phoneme data to entropy coding to perform data compression.

A twenty-seventh aspect of the present invention provides a program for making a computer act as:

data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound; and

restoring means for decoding the acquired phoneme data.

A twenty-eighth aspect of the present invention provides a program for making a computer act as:

data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound;

restoring means for decoding the acquired phoneme data;

phoneme data storing means for storing the acquired phoneme data or the decoded phoneme data;

sentence input means for inputting sentence information representing a sentence; and

synthesizing means for retrieving from the phoneme data storing means, phoneme data representing waveforms of phonemes composing the sentence, and combining the retrieved phoneme data pieces to generate data representing synthesized sound.

A twenty-ninth aspect of the present invention provides a computer readable recording medium having a program recorded thereon for making a computer act as:

a filter for acquiring a sound signal representing a waveform of sound and filtering the sound signal to extract a pitch signal;

phase adjusting means for delimiting the sound signal into sections based on the pitch signal extracted by the filter and adjusting the phase for each section based on the correlation between the section and the pitch signal;

sampling means for determining a sampling length for each section with the phase adjusted by the phase adjusting means, based on the phase, and performing sampling with the sampling length to generate a sampling signal;

sound signal processing means for processing the sampling signal into a pitch waveform signal based on the result of the adjustment by the phase adjusting means and the value of the sampling length; and

pitch waveform signal dividing means for detecting a boundary of adjacent phonemes included in the sound represented by the pitch waveform signal and/or an end of the sound, and dividing the pitch waveform signal at the detected boundary and/or end.

A thirtieth aspect of the present invention provides a computer readable recording medium having a program recorded thereon for making a computer act as:

sound signal processing means for acquiring a sound signal representing a waveform of sound, and processing the sound signal into a pitch waveform signal by substantially equalizing the phases of sections where the sound signal is divided into the sections for a unit pitch of the sound; and

pitch waveform signal dividing means for detecting a boundary of adjacent phonemes included in the sound represented by the pitch waveform signal and an end of the sound, and dividing the pitch waveform signal at the detected boundary and end.

A thirty-first aspect of the present invention provides a computer readable recording medium having a program recorded thereon for making a computer act as:

means for detecting, for pitch waveform signal representing a waveform of sound, a boundary of adjacent phonemes included in the sound represented by the pitch waveform signal and/or an end of the sound; and

means for dividing the pitch waveform signal at the detected boundary and/or end.

A thirty-second aspect of the present invention provides a computer readable recording medium having a program recorded thereon for making a computer act as:

a filter for acquiring a sound signal representing a waveform of sound and filtering the sound signal to extract a pitch signal;

phase adjusting means for delimiting the sound signal into sections based on the pitch signal extracted by the filter and adjusting the phase for each section based on the correlation between the section and the pitch signal;

sampling means for determining a sampling length for each section with the phase adjusted by the phase adjusting means, based on the phase, and performing sampling with the sampling length to generate a sampling signal;

sound signal processing means for processing the sampling signal into a pitch waveform signal based on the result of the adjustment by the phase adjusting means and the value of the sampling length;

phoneme data generating means for detecting a boundary of adjacent phonemes included in the sound represented by the pitch waveform signal and/or an end of the sound, and dividing the pitch waveform signal at the detected boundary and/or end to generate phoneme data; and

data compressing means for subjecting the generated phoneme data to entropy coding to perform data compression.

A thirty-third aspect of the present invention provides a computer readable recording medium having a program recorded thereon for making a computer act as:

sound signal processing means for acquiring a sound signal representing a waveform of sound, and processing the sound signal into a pitch waveform signal by substantially equalizing the phases of sections where the sound signal is divided into the sections for a unit pitch of the sound;

phoneme data generating means for detecting a boundary of adjacent phonemes included in the sound represented by the pitch waveform signal and/or an end of the sound, and dividing the pitch waveform signal at the detected boundary and/or end to generate phoneme data; and

data compressing means for subjecting the generated phoneme data to entropy coding to perform data compression.

A thirty-fourth aspect of the present invention provides a computer readable recording medium having a program recorded thereon for making a computer act as:

means for detecting, for pitch waveform signal representing a waveform of sound, a boundary of adjacent phonemes included in the sound represented by the pitch waveform signal and/or an end of the sound;

phoneme data generating means for dividing the pitch waveform signal at the detected boundary and/or end to generate phoneme data; and

data compressing means for subjecting the generated phoneme data to entropy coding to perform data compression.

A thirty-fifth aspect of the present invention provides a computer readable recording medium having a program recorded thereon for making a computer act as:

data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound; and

restoring means for decoding the acquired phoneme data.

A thirty-sixth aspect of the present invention provides a computer readable recording medium having a program recorded thereon for making a computer act as:

data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound;

restoring means for decoding the acquired phoneme data;

phoneme data storing means for storing the acquired phoneme data or the decoded phoneme data;

sentence input means for inputting sentence information representing a sentence; and

synthesizing means for retrieving from the phoneme data storing means, phoneme data representing waveforms of phonemes composing the sentence, and combining the retrieved phoneme data pieces to generate data representing synthesized sound.

A thirty-seventh aspect of the present invention provides a computer readable recording medium having a program recorded thereon for making a computer act as:

a filter for acquiring a sound signal representing a waveform of sound and filtering the sound signal to extract a pitch signal;

phase adjusting means for delimiting the sound signal into sections based on the pitch signal extracted by the filter and adjusting the phase for each section based on the correlation between the section and the pitch signal;

sampling means for determining a sampling length for each section with the phase adjusted by the phase adjusting means, based on the phase, and performing sampling with the sampling length to generate a sampling signal;

sound signal processing means for processing the sampling signal into a pitch waveform signal based on the result of the adjustment by the phase adjusting means and the value of the sampling length; and

pitch waveform signal dividing means for detecting a boundary of adjacent phonemes included in the sound represented by the pitch waveform signal and/or an end of the sound, and dividing the pitch waveform signal at the detected boundary and/or end.

A thirty-eighth aspect of the present invention provides a computer readable recording medium having a program recorded thereon for making a computer act as:

sound signal processing means for acquiring a sound signal representing a waveform of sound, and processing the sound signal into a pitch waveform signal by substantially equalizing the phases of sections where the sound signal is divided into the sections for a unit pitch of the sound; and

pitch waveform signal dividing means for detecting a boundary of adjacent phonemes included in the sound represented by the pitch waveform signal and/or an end of the sound, and dividing the pitch waveform signal at the detected boundary and/or end.

A thirty-ninth aspect of the present invention provides a computer readable recording medium having a program recorded thereon for making a computer act as:

means for detecting, for pitch waveform signal representing a waveform of sound, a boundary of adjacent phonemes included in the sound represented by the pitch waveform signal and/or an end of the sound; and

means for dividing the pitch waveform signal at the detected boundary and/or end.

A fortieth aspect of the present invention provides a computer readable recording medium having a program recorded thereon for making a computer act as:

a filter for acquiring a sound signal representing a waveform of sound and filtering the sound signal to extract a pitch signal;

phase adjusting means for delimiting the sound signal into sections based on the pitch signal extracted by the filter and adjusting the phase for each section based on the correlation between the section and the pitch signal;

sampling means for determining a sampling length for each section with the phase adjusted by the phase adjusting means, based on the phase, and performing sampling with the sampling length to generate a sampling signal;

sound signal processing means for processing the sampling signal into a pitch waveform signal based on the result of the adjustment by the phase adjusting means and the value of the sampling length;

phoneme data generating means for detecting a boundary of adjacent phonemes included in the sound represented by the pitch waveform signal and/or an end of the sound, and dividing the pitch waveform signal at the detected boundary and/or end to generate phoneme data; and

data compressing means for subjecting the generated phoneme data to entropy coding to perform data compression.

A forty-first aspect of the present invention provides a computer readable recording medium having a program recorded thereon for making a computer act as:

sound signal processing means for acquiring a sound signal representing a waveform of sound, and processing the sound signal into a pitch waveform signal by substantially equalizing the phases of sections where the sound signal is divided into the sections for a unit pitch of the sound;

phoneme data generating means for detecting a boundary of adjacent phonemes included in the sound represented by the pitch waveform signal and/or an end of the sound, and dividing the pitch waveform signal at the detected boundary and/or end to generate phoneme data; and

data compressing means for subjecting the generated phoneme data to entropy coding to perform data compression.

A forty-second aspect of the present invention provides a computer readable recording medium having a program recorded thereon for making a computer act as:

means for detecting, for pitch waveform signal representing a waveform of sound, a boundary of adjacent phonemes included in the sound represented by the pitch waveform signal and/or an end of the sound;

phoneme data generating means for dividing the pitch waveform signal at the detected boundary and/or end to generate phoneme data; and

data compressing means for subjecting the generated phoneme data to entropy coding to perform data compression.

A forty-third aspect of the present invention provides a computer readable recording medium having a program recorded thereon for making a computer act as:

data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound; and

restoring means for restoring the phase of the acquired phoneme data to the phase before the process.

A forty-fourth aspect of the present invention provides a computer readable recording medium having a program recorded thereon for making a computer act as:

data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound;

restoring means for decoding the acquired phoneme data;

phoneme data storing means for storing the acquired phoneme data or the phoneme data with the restored phase;

sentence input means for inputting sentence information representing a sentence; and

synthesizing means for retrieving from the phoneme data storing means, phoneme data representing waveforms of phonemes composing the sentence, and combining the retrieved phoneme data pieces to generate data representing synthesized sound.

According to the present invention, there are provided a pitch waveform signal division device, a pitch waveform signal division method and a program to efficiently compress data capacity of data representing sound.

Furthermore, according to the present invention, there are provided a sound signal compression device and a sound signal compression method for efficiently compressing a data capacity of data representing sound, a sound signal restoration device and a sound signal restoration method for restoring the data compressed by the sound signal compression device and the sound signal compression method, a database and a recording medium for holding data compressed by the sound signal compression device and the sound signal compression method, and a sound synthesis device and a sound synthesis method for performing sound synthesis using the data compressed by the sound signal compression device and the sound signal compression method.

### BRIEF DESCRIPTION OF THE DRAWINGS

FIG. 1 is a block diagram showing a constitution of a pitch waveform data divider according to a first embodiment of the invention;

FIG. 2 is a diagram showing a former half of a flow of operations of the pitch waveform data divider in FIG. 1;

FIG. 3 is a diagram showing a latter half of the flow of operations of the pitch waveform data divider in FIG. 1;

FIGS. 4(a) and 4(b) are graphs showing a waveform of sound data before being phase-shifted and 4(c) is a graph representing a waveform of the sound data after being phase-shifted;

FIG. 5(a) is a graph showing timing at which the pitch waveform data divider in FIG. 1 or FIG. 6 delimits the waveform in FIG. 17(a) and FIG. 5(b) is a graph showing timing at which the pitch waveform data divider in FIG. 1 or FIG. 6 delimits the waveform in FIG. 17(b);

FIG. 6 is a block diagram showing a constitution of a pitch waveform data divider according to a second embodiment of the invention;

FIG. 7 is a block diagram showing a constitution of a pitch waveform extracting unit of the pitch waveform data divider;

FIG. 8 is a block diagram showing a constitution of a phoneme data compressing unit showing a constitution of a synthesized sound using system according to a third embodiment of the invention;

FIG. 9 is a block diagram showing a constitution of a sound synthesizing unit;

FIG. 10 is a block diagram showing a constitution of a sound synthesizing unit;

FIG. 11 is a diagram schematically showing a data structure of a sound piece database;

FIG. 12 is a flowchart showing processing of a personal computer for carrying out a function of a phoneme data supply unit;

FIG. 13 is a flowchart showing processing in which the personal computer for carrying out the function of the phoneme data using unit acquires phoneme data;

FIG. 14 is a flowchart showing processing for sound synthesis in the case in which the personal computer for carrying out the function of the phoneme data using unit has acquired free text data;

FIG. 15 is a flowchart showing processing in the case in which the personal computer for carrying out the function of the phoneme data using unit has acquired distributed character string data;

FIG. 16 is a flowchart showing processing of sound synthesis in the case in which the personal computer for carrying out the function of the phoneme data using unit has acquired fixed form message data and utterance speed data; and

FIG. 17(a) is a graph showing an example of a waveform of a sound uttered by a human and FIG. 17(b) is a graph for explaining timing for delimiting a waveform in the conventional technique.

### EMBODIMENTS OF THE INVENTION

Embodiments of the invention will be hereinafter explained with reference to the drawings.

### First Embodiment

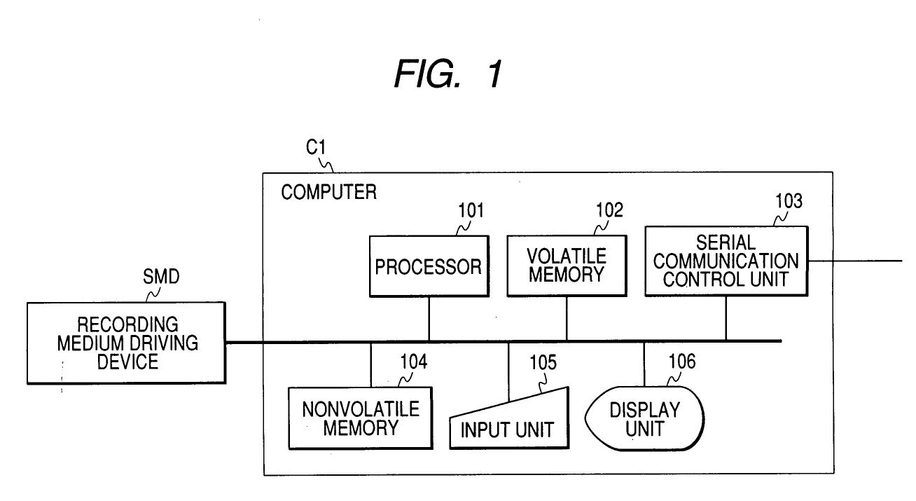

FIG. 1 is a diagram showing a constituting of a pitch waveform data divider according to a first embodiment of the invention. As shown in the figure, this pitch waveform data divider includes a recording medium driving device (e.g., a flexible disk drive or a CD-ROM drive) SMD, which reads data recorded in a recording medium (e.g., a flexible disk or a CD-R (Compact Disc-Recordable)), and a computer C1 connected to a recording medium drive device 200.

As shown in the figure, the computer C100 includes a processor 101 consisting of a CPU (Central Processing Unit), a DSP (Digital Signal Processor), or the like, a volatile memory 102 consisting of a RAM (Random Access Memory) or the like, a nonvolatile memory 104 consisting of a hard disk device or the like, an input unit 105 consisting of a keyboard or the like, a display unit 106 consisting of a liquid crystal display or the like, and a serial communication control unit 103 that consists of a USB (Universal Serial Bus) interface circuit or the like and controls serial communication with the outside.

The computer C1 stores a phoneme delimiting program in advance and executes this phoneme delimiting program to thereby perform processing described later.

### First embodiment: Operations

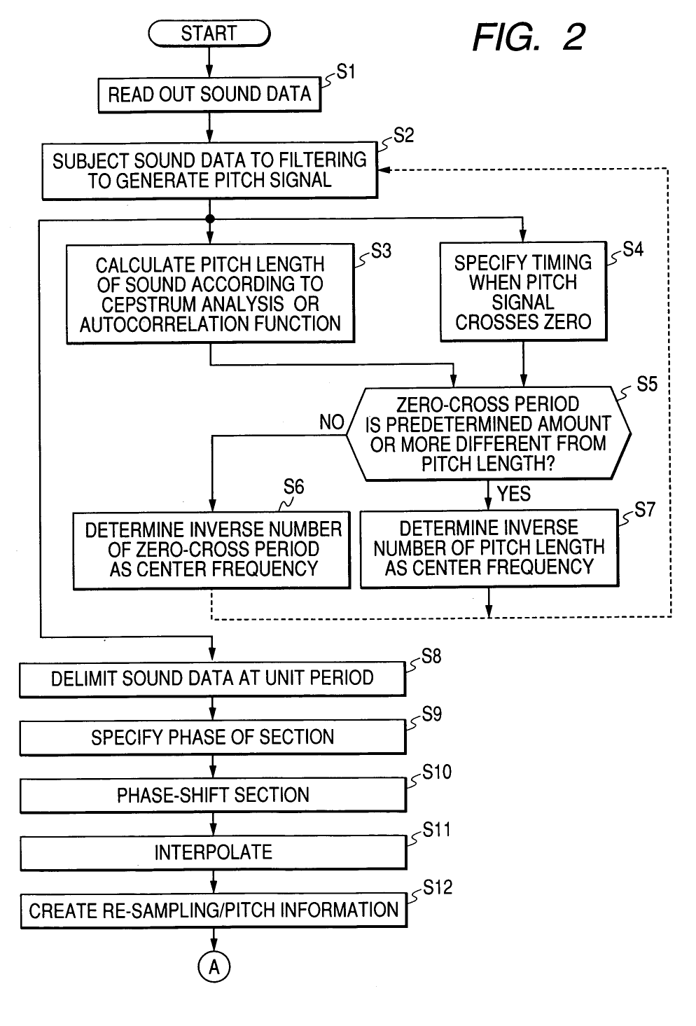

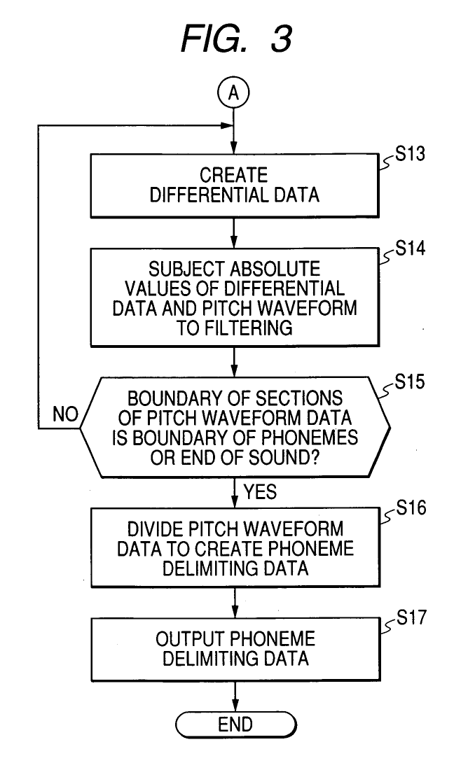

Next, operations of this pitch waveform data divider will be explained with reference to FIG. 2 and FIG. 3. FIG. 2 and FIG. 3 are diagrams showing a flow of operations of the pitch waveform data divider.

When a user sets a recording medium, which has recorded therein sound data representing a waveform of a sound, in the recording medium driving device SMD and instructs the computer C1 to start the phoneme delimiting program, the computer C1 starts processing of the phoneme delimiting program.

Then, first, the computer C1 reads out the sound data from the recording medium via the recording medium driving device SMD (FIG. 2, step S1). Note that it is assumed that the sound data has, for example, a form of a digital signal subjected to PCM (Pulse Code Modulation) and represents a sound subjected to sampling at a fixed period sufficiently shorter than a pitch of the sound.

Next, the computer C1 subjects the sound data read out from the recording medium to filtering to thereby generate filtered sound data (pitch signal) (step S2). It is assumed that the pitch signal consists of data of a digital format having a sampling interval substantially identical with a sampling interval of the sound data.

Note that the computer C1 determines a characteristic of the filtering, which is performed for generating a pitch signal, by performing feedback processing based on a pitch length described later and time when an instantaneous value of the pitch signal reaches zero (time when the pitch signal crosses zero).

In other words, the computer C1 applies, for example, cepstrum analysis and analysis based on an autocorrelation function to the read-out sound data to thereby specify a basic frequency of a sound represented by this sound data and calculates an absolute value of an inverse number of this basic frequency (i.e., a pitch length) (step S3). (Alternatively, the computer C1 may perform both the cepstrum analysis and the analysis based on an autocorrelation function to thereby specify two basic frequencies and calculate an average of absolute values of inverse numbers of these two basic frequencies as a pitch length.)

Note that, as the cepstrum analysis, specifically, first, the computer C1 converts intensity of the read-out sound data into a value substantially equal to a logarithm of an original value (a base of the logarithm is arbitrary) and calculates a spectrum of the sound data, a value of which is converted, using a method of fast Fourier transform (or other arbitrary means for generating data representing a result obtained by subjecting a discrete variable to Fourier transform). Then, the computer C1 specifies a minimum value among frequencies giving a maximum value of this cepstrum as a basic frequency.

On the other hand, as the analysis based on an autocorrelation, specifically, the computer C1 uses the read-out sound data to, first, specifies an autocorrelation function r(1) represented by a right part of formula 1. Then, the computer C1 specifies a minimum value exceeding a predetermined lower limit value among frequencies, which give a maximum value of a function (a periodogram) obtained as a result of subjecting the autocorrelation function r(1) to the Fourier transform, as a basic frequency.

$$r ( 1 ) = \frac{1}{N} {\sum }_{t = 0}^{N - 1 - 1} \{ x ( t + 1 ) \cdot x ( t ) \} \qquad ( Formula 1 )$$

On the other hand, the computer C1 specifies timing at which time when the pitch signal crosses zero comes (step S4). The computer C1 judges whether the pitch length and the period of zero-cross of the pitch signal are different from each other by a predetermined amount or more (step S5). When it is judged that the pitch length and the period are not different, the computer C1 performs the filtering with a characteristic of a band-pass filter having an inverse number of the period of zero-cross as a center frequency (step S6). On the other hand, when it is judged that the pitch length and the period of zero-cross are different by the predetermined amount or more, the computer C1 performs the filtering with a characteristic of a band-pass filter having an inverse number of the pitch length as a center frequency (step S7). Note that, in both the cases, it is desirable that a pass band width of the filtering is a pass band width in which an upper limit of a pass band is always within a frequency twice as large as a basic frequency of a sound represented by sound data.

Next, the computer C1 delimits the sound data read out from the recording medium at timing when a boundary of a unit period (e.g., one period) of the generated pitch signal comes (specifically, timing when the pitch signal crosses zero) (step S8). For each of sections formed by delimiting the sound data, the computer C1 calculates correlation between phases, which are obtained by changing a phase of the sound data in this section in various ways, and a pitch signal in this section and specifies a phase of the sound data at the time when the correlation is the highest as a phase of the sound data in this section (step S9). The computer C1 phase-shifts the respective sections of the sound data such that the sections have substantially the same phases (step S10).

Specifically, the computer C1 calculates, for example, a value cor represented by a right part of formula 2 for each of the sections in respective cases in which a value of φ (φ is an integer equal to or larger than 0) representing a phase is changed in various ways. The computer C1 specifies a value ψ of φ, at which the value cor is maximized, as a value representing a phase of the sound data in this section. As a result, a value of a phase having a highest correlation with the pitch signal is decided for this section. The computer C1 phase-shifts the sound data in this section by (−ψ).

$$cor = {\sum }_{i = 1}^{n} \{ f ( i - ϕ ) \cdot g ( i ) \} \qquad ( Formula 2 )$$

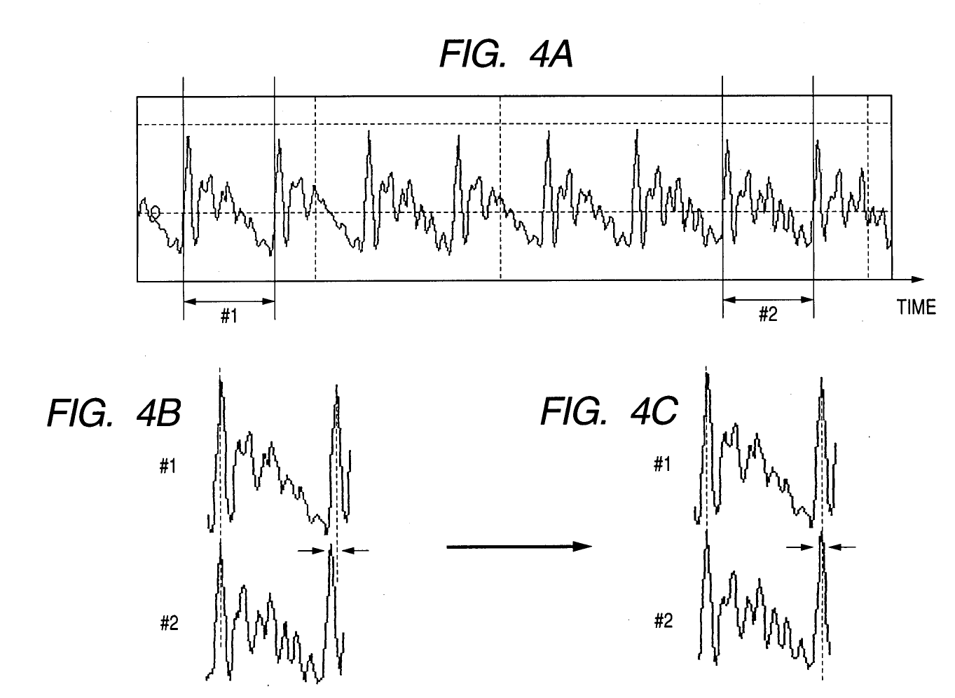

An example of a waveform represented by data obtained by phase-shifting sound data as described above is shown in FIG. 4(c). In a waveform of sound data before phase-shift shown in FIG. 4(a), two sections indicated as “#1” and “#2” have, as shown in FIG. 4(b), phases different from each other because of an influence of fluctuation of pitches. On the other hand, as shown in FIG. 4(c), in sections #1 and #2 represented by phase-shifted sound data, the influence of fluctuation of pitches is eliminated and phases are the same. In addition, as shown in FIG. 4(a), values of start points of the respective sections are close to zero.

Note that it is desirable that a temporal length of a section is a length of about one pitch. As the section is longer, the number of samples in the section increases, a data amount of pitch waveform data increases, or a sampling interval increases to cause a problem in that a sound represented by pitch waveform data becomes inaccurate.

Next, the computer C1 subjects the phase-shifted sound data to Lagrange's interpolation (step S11). In other words, the computer C1 generates data representing a value interpolating samples of the phase-shifted data according to a method of the Lagrange's interpolation. The phase-shifted sound data and Lagrange's interpolation data constitute sound data after interpolation.

Next, the computer C1 subjects the respective sections of the sound data after interpolation to sampling again (resampling). In addition, the computer C1 also generates pitch information that is data indicating the original numbers of samples in the respective sections (step S12). The computer C1 sets the numbers of samples in the respective sections of the pitch waveform data such that the numbers of samples are substantially equal and performs sampling such that intervals are equal in an identical section.

If the sampling interval for the sound data read out from the recording medium is known, the pitch information functions as information representing an original time length of sections for a unit pitch of the sound data.

Next, for one pitch at the top, which is not used for creation of differential data, of sections for second and subsequent one pitch from the top of sound data (i.e., pitch waveform data), the time lengths of the respective sections of which are set to be the same in step S12, the computer C1 generates data representing a sum of a difference (i.e., differential data) between an instantaneous value of a waveform represented by data for the one pitch and an instantaneous value of a waveform represented by data for one pitch immediately before the one pitch (FIG. 3, step S13).

In step S13, specifically, for example, when the computer C1 specifies kth one pitch from the top, the computer only has to temporarily store data for (k−1)th one pitch in advance and generate data representing a value Δk of a right part of formula 3 using the specified kth one pitch and the data for the (k−1)th one pitch temporarily stored.

$${Δ}_{k} = {\sum }_{j = 1}^{n} \{ {h}_{k} ( j ) - {h}_{K - 1} ( j ) \} \qquad ( Formula 3 )$$

The computer C1 generates data representing a result of filtering latest differential data generated in step S13 with a low pass filter (differential data subjected to filtering) and data representing a result of calculating an absolute value of the pitch signal, which represents a pitch of a section for two pitches used for generating the differential data, and filtering the pitch signal with the low-pass filter (a pitch signal subjected to filtering) (step S14).

Note that a pass band characteristic of the filtering for the differential data and the absolute value of the pitch signal in step S14 only has to be a characteristic with which a probability of an error, which is unexpectedly caused by the computer C1 or the like in the differential data or the pitch signal, causing mistake in the judgment performed in step S15 is sufficiently low. The pass band characteristic only has to be determined empirically by performing an experiment. Note that, in general, it is satisfactory if the pass band characteristic is a pass band characteristic of a secondary IIR (Infinite Impulse Response) type low-pass filter.

Next, the computer C1 judges whether the boundary of the section for latest one pitch and a section for one pitch immediately before the latest one pitch of the pitch waveform data is a boundary of two phonemes different from each other (or an end of a sound), the middle of one phoneme, the middle of a frictional sound, or the middle of a silent state (step S15).

In step S15, the computer C1 performs the judgment utilizing the fact that, for example, a voice uttered by a human has characteristics (a) and (b) described below.

(a) When two sections for one pitch adjacent to each other represent a waveform of an identical phoneme, since correlation between both the sections is high, intensity of a difference between both the sections is small. On the other hand, when the two sections for one pitch represent waveforms of phonemes different from each other (or, one of the sections represents a silent state), since correlation between both the sections is low, intensity of a difference between both the sections is large.

(b) However, the frictional sound has few spectrum components equivalent to basic frequency components and high frequency components of a sound emitted by a vocal band and does not show clear periodicity. Thus, correlation between two sections for one pitch adjacent to each other representing an identical frictional sound is low.

More specifically, for example, in step S15, the computer C1 performs the judgment in accordance with judgment conditions (1) to (4) described below.

(1) When intensity of the differential data subjected to filtering is equal to or higher than a predetermined first reference value and intensity of the pitch signal is equal to or higher than a predetermined second reference value, the computer C1 judges that a boundary of two sections for one pitch used for generation of the differential data is a boundary of two phonemes different from each other (or an end of a sound).

(2) When intensity of the differential data subjected to filtering is equal to or higher than the first reference value and intensity of the pitch signal is lower than the second reference value, the computer C1 judges that a boundary of two sections used for generation of the differential data is the middle of a frictional sound.

(3) When intensity of the differential data subjected to filtering is lower than the first reference value and intensity of the pitch signal is lower than the second reference value, the computer C1 judges that a boundary of two sections used for generation of the differential data is the middle of a silent state.

(4) When intensity of the differential data subjected to filtering is lower than the first reference value and intensity of the pitch signal is equal to or higher than the second reference value, the computer C1 judges that a boundary of two sections used for generation of the differential data is the middle of one phoneme.

Note that as a specific value of intensity of the pitch signal subjected to filtering, for example, the computer C1 only has to use a peak-to-peak value of absolute values, an effective value, an average value of absolute values, or the like.

When it is judged in the processing in step S15 that a boundary of a section for latest one pitch of pitch waveform data and a section for one pitch immediately before the latest one pitch is a boundary of two phonemes different from each other (or an end of a sound) (i.e., a result of the judgment falls under the case of (1)), the computer C1 divides the pitch waveform data in the boundary of two sections (step S16). On the other hand, when it is judged that the boundary is not a boundary of two phonemes different from each other (or an end of a sound), the computer C1 returns the processing to step S13.

As a result of repeatedly performing the processing of steps S13 to S16, the pitch waveform data is divided into a set of sections (phoneme data) equivalent to one phoneme. The computer C1 outputs the phoneme data and the pitch information generated in step S12 to the outside via the serial communication control unit of the computer C1 itself (step S17).

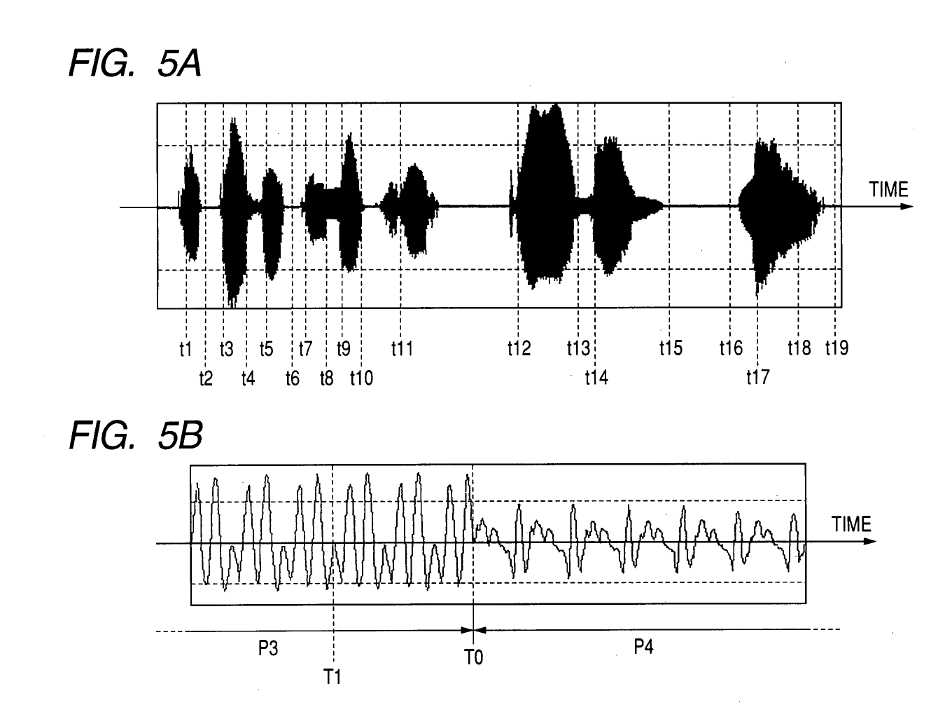

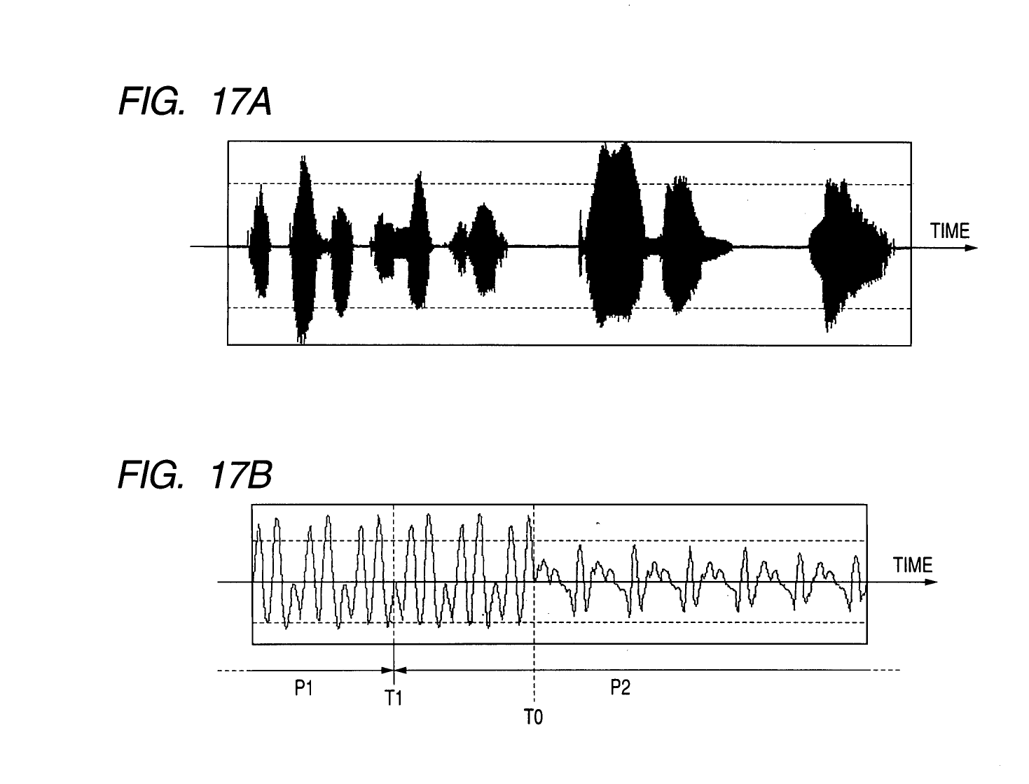

Phoneme data obtained as a result of applying the processing explained above to the sound data having the waveform shown in FIG. 17(a) is obtained by delimiting this sound data at timing “t1” to timing “t9” that are boundaries of different phonemes (or ends of sounds), for example, as shown in FIG. 5(a).

When the sound data having the waveform shown in FIG. 17(b) is delimited by the processing explained above to have phoneme data, unlike the delimiting method shown in FIG. 17(b), as shown in FIG. 5(b), a boundary “T0” of adjacent two phonemes is selected as timing for delimiting correctly. Consequently, waveforms of plural phonemes are prevented from mixing in waveforms represented by obtained respective phoneme data (e.g., in FIG. 5(b), waveforms of portions indicated as “P3” or “P4”).

The sound data is processed into pitch waveform data and, then, delimited. The pitch waveform data is sound data in which a time length of a section for a unit pitch is standardized and the influence of fluctuation of pitches is removed. Consequently, the respective phoneme data have accurate periodicity over the entire sound data.

Since the phoneme data has the characteristics explained above, if data compression according to a method of entropy coding (specifically, a method of arithmetic coding, Huffman coding, etc.) to the phoneme data, the phoneme data is compressed efficiently.

Since the sound data is processed into the pitch waveform data, the influence of fluctuation of pitches is removed. As a result, a sum of a difference of two sections for one pitch adjacent to each other represented by the pitch waveform data is a sufficiently small value if these two sections represent a waveform of an identical phoneme. Therefore, it is less likely that an error occurs in the judgment in step S15.

Note that, since it is possible to specify original time lengths of respective sections of the pitch waveform data using the pitch information, it is possible to easily restore the original sound data by restoring the time length of the respective sections of the pitch waveform data to a time length in the original sound data.

Note that a constitution of this pitch waveform data divider is not limited to the one described above.

For example, the computer C1 may acquire sound data serially transmitted from the outside via the serial communication control unit. In addition, the computer C1 may acquire sound data from the outside through a communication line such as a telephone line, a private line, or a satellite line. In this case, the computer C1 only has to include, for example, a modem and a DSU (Data Service Unit). If the computer C1 acquires sound data from sources other than the recording medium driving device SMD, the computer C1 is not always required to include the recording medium driving device SMD.

The computer C1 may include a sound collecting device consisting of a microphone, an AF amplifier, a sampler, an A/D (Analog-to-Digital) converter, a PCM encoder, and the like. The sound collecting device only has to amplify a sound signal representing a sound collected by the own microphone and subject the sound signal to sampling and A/D conversion and, then, apply PCM modulation to the sound signal subjected to sampling to thereby acquire sound data. Note that the sound data acquired by the computer C1 is not always required to be a PCM signal.

The computer C1 may write phoneme data in a recording medium, which is set in the recording medium driving device SMD, via the recording medium driving device SMD. Alternatively, the computer C1 may write phoneme data in an external storage consisting of a hard disk device or the like. In these cases, the computer C1 only has to include a recording medium driving device and a control circuit such as a hard disk controller.

The computer C1 may apply entropy coding to phoneme data and, then, output the phoneme data subjected to the entropy coding in accordance with control of the phoneme delimiting program and other programs stored in the computer C1.

The computer C1 does not have to perform the cepstrum analysis or the analysis based on an autocorrelation function. In this case, the computer C1 only has to treat an inverse number of a basic frequency, which is calculated by a method of one of the cepstrum analysis and the analysis based on an autocorrelation coefficient, directly as a pitch length.

An amount, with which the computer C1 phase-shifts sound data in respective sections of sound data, does not always have to be (−ψ). For example, the computer C1 may phase-shift, with an actual number common to respective sections representing an initial phase set as δ, sound data by (−ψ+δ) for the respective sections. A position, where the computer C1 delimits sound data, does not always have to be timing when a pitch signal crosses zero. For example, the position may be timing when the pitch signal takes a predetermined value other than zero.

However, if an initial phase α is set to 0 and sound data is delimited at timing when a pitch signal crosses zero, values of start points of respective sections take values close to zero. Thus, an amount of noise included in the respective sections by delimiting the sound data into the respective sections is reduced.

Differential data does not always have to be generated sequentially in accordance with an order of arrangement of sound data among respective sections. Respective differential data representing a sum of a difference of sections for one pitch adjacent to each other in pitch waveform data may be generated in an arbitrary order or plural differential data may be generated in parallel. Filtering of the differential data does not always have to be performed sequentially. The filtering of differential data may be performed in an arbitrary order or the filtering of plural differential data may be performed in parallel.

Interpolation of phase-shifted sound data does not always have to be performed by the method of the Lagrange's interpolation. For example, the interpolation may be performed by a method of linear interpolation or the interpolation itself may be omitted.

The computer C1 may generate and output information specifying which one of phoneme data represents a frictional sound and a silent state.

If fluctuation of pitches of sound data to be processed into phoneme data is in a negligible degree, the computer C1 does not have to perform phase-shift of the sound data. The computer may consider that the sound data and pitch waveform data are the same and perform the processing in step S13 and the subsequent steps. Interpolation and resampling of sound data are not processing that is always required.

Note that the computer C1 does not have to be a dedicated system and may be a personal computer or the like. The phoneme delimiting program may be installed from a medium (a CD-ROM, an MO, a flexible disc, etc.) having stored therein the phoneme delimiting program to the computer C1. The phoneme delimiting program may be uploaded to a bulletin board system (BBS) on a communication line and distributed through the communication line. It is also possible that a carrier wave is modulated by a signal representing the phoneme delimiting program, an obtained modulated wave is transmitted, and an apparatus having received this modulated wave demodulates the modulated wave to restore the phoneme delimiting program.

The phoneme delimiting program is started in the same manner as other application programs under the control of an OS to cause the computer C1 to execute the phoneme delimiting program, whereby the processing described above can be executed. Note that when the OS carries out a part of the processing, a portion for controlling the processing may be removed from the phoneme delimiting program stored in the recording medium.

### Second Embodiment

Next, a second embodiment of the invention will be explained.

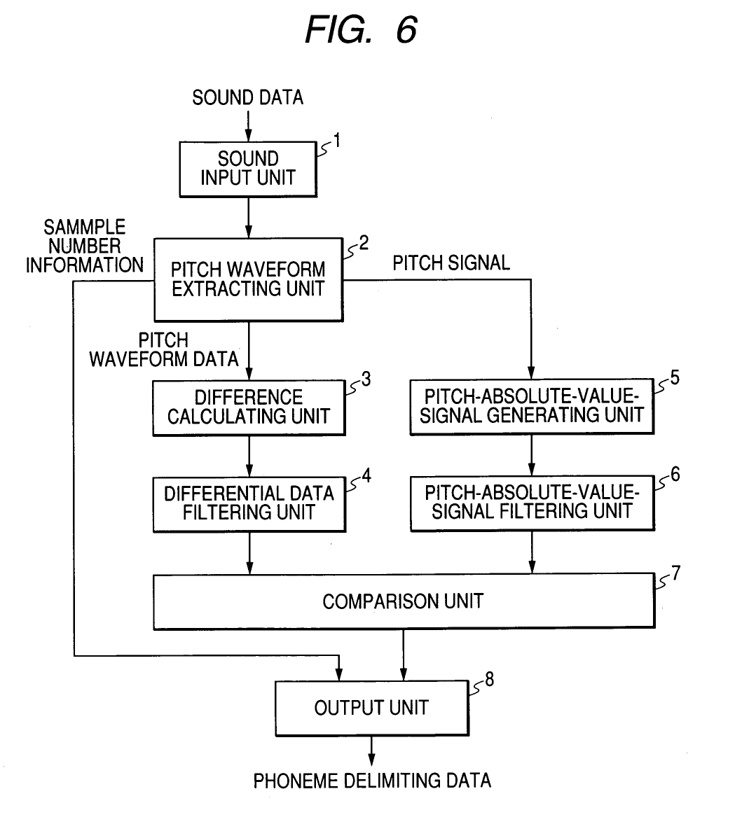

FIG. 6 is a diagram showing a constitution of a pitch waveform data divider according to the second embodiment of the invention. As shown in the figure, this pitch waveform data divider includes a sound input unit 1, a pitch waveform extracting unit 2, a difference calculating unit 3, a differential data file filter unit 4, a pitch-absolute-value-signal generating unit 5, a pitch-absolute-value-signal filtering unit 6, a comparison unit 7, and an output unit 8.

The sound input unit 1 is constituted by, for example, a recording medium driving device or the like similar to the recording medium driving device SMD in the first embodiment.

The sound input unit 1 acquires sound data representing a waveform of a sound by, for example, reading the sound data from a recording medium having recorded therein this sound data and supplies the sound data to the pitch waveform extracting unit 2. Note that it is assumed that the sound data has a form of a digital signal subjected to the PCM modulation and represents a sound subjected to sampling at a fixed period sufficiently shorter than a pitch of a sound.

The pitch waveform extracting unit 2, the difference calculating unit 3, the differential data filter unit 4, the pitch-absolute-value-signal generating unit 5, the pitch-absolute-value-signal filtering unit 6, the comparison unit 7, and the output unit 8 includes a processor such as a DSP or a CPU and a memory that stores a program to be executed by this processor.

Note that a single processor may carry out a part or all of functions of the pitch waveform extracting unit 2, the difference calculating unit 3, the differential data filter unit 4, the pitch-absolute-value-signal generating unit 5, the pitch-absolute-value-signal filtering unit 6, the comparison unit 7, and the output unit 8.

The pitch waveform extracting unit 2 divides sound data supplied from the sound input unit 1 into sections for a unit pitch (e.g., for one pitch) of a sound represented by this sound data. The pitch waveform extracting unit 2 subjecting the respective sections formed by diving the sound data to phase shift and resampling to arrange time lengths and phases of the respective sections to be substantially identical. The pitch waveform extracting unit 2 supplies the sound data (pitch waveform data) with the phases and the time length of the respective sections arranged to the difference calculating unit 3.

The pitch waveform extracting unit 2 generates a pitch signal described later, uses this pitch signal as described later, and supplies the pitch signal to the pitch-absolute-value-signal generating unit 5.

The pitch waveform extracting unit 2 generates sample number information indicating the numbers of original samples of the respective sections of this sound data and supplies the sample number information to the output unit 8.

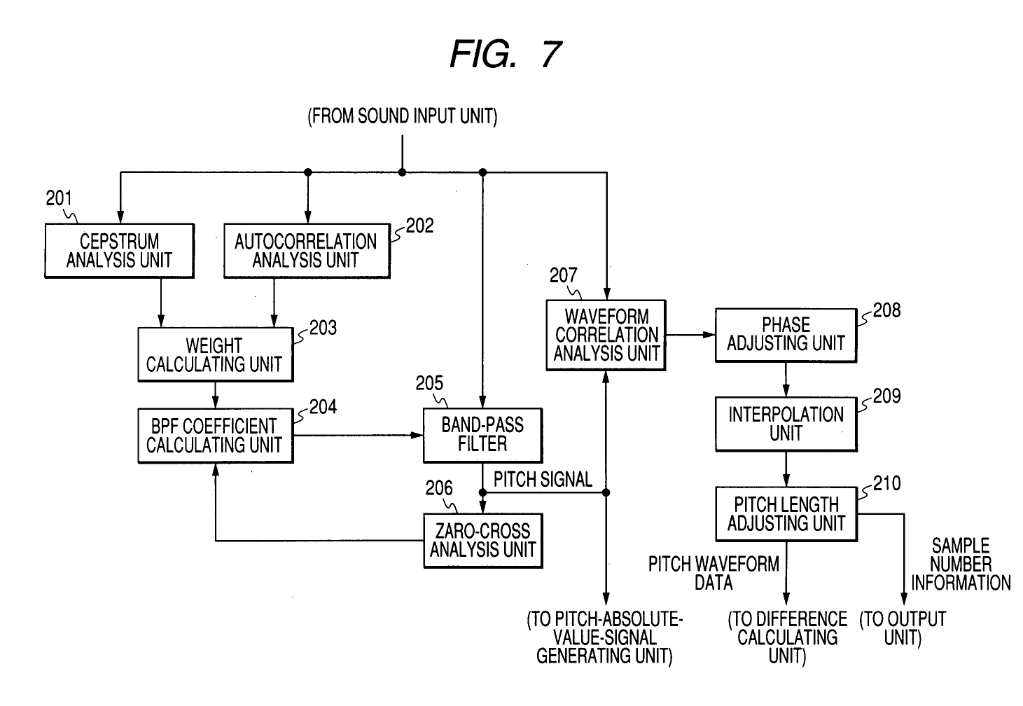

For example, as shown in FIG. 7, functionally, the pitch waveform extracting unit 2 includes a cepstrum analysis unit 201, an autocorrelation analysis unit 202, a weight calculating unit 203, a BPF (band pass filter) coefficient calculating unit 204, a band-pass filter 205, a zero-cross analysis unit 206, a waveform correlation analysis unit 207, a phase adjusting unit 208, an interpolation unit 209, and a pitch length adjusting unit 210.

Note that a single processor may carry out a part or all of functions of the cepstrum analysis unit 201, the autocorrelation analysis unit 202, the weight calculating unit 203, the BPF (band pass filter) coefficient calculating unit 204, the band-pass filter 205, the zero-cross analysis unit 206, the waveform correlation analysis unit 207, the phase adjusting unit 208, the interpolation unit 209, and the pitch length adjusting unit 210.

The pitch waveform extracting unit 2 specifies a length of a pitch using both the cepstrum analysis and the analysis based on an autocorrelation function.

First, the cepstrum analysis unit 201 applies the cepstrum analysis to sound data supplied from the sound input unit 1 to thereby specify a basic frequency of a sound represented by this sound data. The cepstrum analysis unit 201 generates data indicating the specified basic frequency and supplies the data to the weight calculating unit 203.

Specifically, when the sound data is supplied from the sound input unit 1, first, the cepstrum analysis unit 201 converts intensity of this sound data into a value substantially equal to a logarithm of an original value. (A base of the logarithm is arbitrary.) The cepstrum analysis unit 201 calculates a spectrum (i.e., cepstrum) of the sound data, a value of which is converted, with a method of the fast Fourier transform (or, other arbitrary methods of generating data representing a result obtained by subjecting a discrete variable to the Fourier transform).

The cepstrum analysis unit 201 specifies a minimum value among frequencies giving a maximum value of this cepstrum as a basic frequency. The cepstrum analysis unit 201 generates data indicating the specified basic frequency and supplies the data to the weight calculating unit 203.

On the other hand, when the sound data is supplied from the sound input unit 1, the autocorrelation analysis unit 202 specifies a basic frequency of a sound represented by this sound data on the basis of an autocorrelation function of a waveform of the sound data. The autocorrelation analysis unit 202 generates data indicating the specified basic frequency and supplies the data to the weight calculating unit 203.

Specifically, when the sound data is supplied from the sound input unit 1, first, the autocorrelation analysis unit 202 specifies the autocorrelation function r(1) described above. The autocorrelation analysis unit 202 specifies a minimum value exceeding a predetermined lower limit value among frequencies giving a maximum value of a periodogram, which is obtained as a result of subjecting the specified autocorrelation function r(1) to the Fourier transform, as a basic frequency. The autocorrelation analysis unit 202 generates data indicating the specified basic frequency and supplies the data to the weight calculating unit 203.

When total two data indicating basic frequencies are supplied from the cepstrum analysis unit 201 and the autocorrelation analysis unit 202, respectively, the weight calculating unit 203 calculates an average of absolute values of inverse numbers of the basic frequencies indicated by the two data. The weight calculating unit 203 generates data indicating a calculated value (i.e., an average pitch length) and supplies the data to the BPF coefficient calculating unit 204.

When the data indicating an average pitch length is supplied from the weight calculating unit 203 and a zero-cross signal described later is supplied from the zero-cross analysis unit 206, the BPF coefficient calculating unit 204 judges whether the average pitch length and a period of zero-cross are different from each other by a predetermined amount or more on the basis of the supplied data and zero-cross signal. When it is judged that the average pitch length and the period of zero-cross are not different, the BPF coefficient calculating unit 204 controls a frequency characteristic of the band-pass filter 205 such that an inverse number of the period of zero-cross is set as a center frequency (a frequency in the center of a pass band of the band-pass filter 205).

The band-pass filter 205 carries out a function of a filter of an FIR (Finite Impulse Response) type having a variable center frequency.

Specifically, the band-pass filter 205 sets an own center frequency to a value complying with the control of the BPF coefficient calculating unit 204. The band-pass filter 205 subjects sound data supplied from the sound input unit 1 to filtering and supplies the sound data subjected to filtering (a pitch signal) to the zero-cross analysis unit 206, the waveform correlation analysis unit 207, and the pitch-absolute-value-signal generating unit 5. It is assumed that the pitch signal consists of data of a digital format having sampling interval substantially identical with a sampling interval of the sound data.

Note that it is desirable that a pass band width of the band-pass filer 205 is a pass band width in which an upper limit of a pass band of the band-pass filter 205 is always within a frequency twice as large as a basic frequency of a sound represented by sound data.

The zero-cross analysis unit 206 specifies timing at which time when an instantaneous value of the pitch signal supplied from the band-pass filter 205 reaches zero (time when the instantaneous value crosses zero) comes. The zero-cross analysis unit 206 supplies a signal representing the specified timing (a zero-cross signal) to the BPF coefficient calculating unit 204. In this way, a length of a pitch of the sound data is specified.

However, the zero-cross analysis unit 206 may specify timing at which time when an instantaneous value of the pitch signal reaches a predetermined value other than zero comes and supply a signal representing the specified timing to the BPF coefficient calculating unit 204 instead of the zero-cross signal.

When the sound data is supplied from the sound input unit 1 and the pitch signal is supplied from the band-pass filter 205, the waveform correlation analysis unit 207 delimits the sound data at timing when a boundary of a unit period (e.g., one period) of the pitch signal comes. For each of sections formed by delimiting the sound data, the waveform correlation analysis unit 207 calculates correlation between phases, which are obtained by changing a phase of the sound data in this section in various ways, and a pitch signal in this section and specifies a phase of the sound data at the time when the correlation is the highest as a phase of the sound data in this section. In this way, phases of the sound data are specified for the respective sections.

Specifically, for example, for each of the sections, the waveform correlation analysis unit 207 specifies the value ψ, generates data indicating the value ψ, and supplies the data to the phase adjusting unit 208 as phase data representing a phase of the sound data in this section. Note that it is desirable that a temporal length of a section is a length for about one pitch.

When the sound data is supplied from the sound input unit 1 and the data indicating the phases ψ of the respective sections are supplied from the waveform correlation analysis unit 207, the phase adjusting unit 208 arranges the phases of the respective sections by shifting phases of the sound data in the respective sections by (−ψ). The phase adjusting unit 208 supplies the phase-shifted sound data to the interpolation unit 209.

The interpolation unit 209 applies the Lagrange's interpolation to the sound data (the phase-shifted sound data) supplied from the phase adjusting unit 208 and supplies the sound data to the pitch length adjusting unit 210.

When the sound data subjected to the Lagrange's interpolation is supplied from the interpolation unit 209, the pitch length adjusting unit 210 subjects respective sections of the supplied sound data to resampling to thereby arrange time lengths of the respective sections to be substantially identical with each other. The pitch length adjusting unit 210 supplies the sound data with the time lengths of the respective sections arranged (i.e., pitch waveform data) to the difference calculating unit 3.

The pitch length adjusting unit 210 generates sample number information indicating the numbers of original samples of the respective sections of this sound data (the numbers of samples of the respective sections of the sound data at a point when the sound data is supplied from the sound input unit 1 to the pitch length adjusting unit 210) and supplies the sample number information to the output unit 8. The sample number information is information specifying the original time lengths of the respective sections of the pitch waveform data and is equivalent to the pitch information in the first embodiment.

The difference calculating unit 3 generates respective differential data representing a sum of a difference between a section for one pitch and a section for one pitch immediately before the section in the pitch waveform data (specifically, for example, data representing the value Δk) for the respective sections for second and subsequent one pitch from the top of the pitch waveform data and supplies the differential data to the differential data filter unit 4.

The differential data filter unit 4 generates a result obtained by subjecting the respective differential data supplied from the difference calculating unit 3 to filtering with a low-pass filter (differential data subjected to filtering) and supplies the data to the comparison unit 7.

Note that a pass band characteristic of the filtering for the differential data by the differential data filter unit 4 only has to be a characteristic with which a probability of an error, which is unexpectedly caused in the differential data, causing mistake in judgment described later, which is performed by the comparison unit 7, is sufficiently low. Note that, in general, it is satisfactory if the pass band characteristic of the differential data filter unit 4 is a pass band characteristic of a secondary IIR type low-pass filter.

On the other hand, the pitch-absolute-value-signal generating unit 5 generates a signal representing an absolute value of an instantaneous value of the pitch signal supplied from the pitch waveform extracting unit 2 (a pitch absolute value signal) and supplies the pitch absolute value signal to the pitch-absolute-value-signal filtering unit 6.

The pitch-absolute-value-signal filtering unit 6 generates data representing a result obtained by subjecting the pitch absolute value signal supplied from the pitch-absolute-value-signal generating unit 5 to filtering with a low-pass filter (a pitch signal subjected to filtering) and supplies the pitch signal to the comparison unit 7.

Note that a pass band characteristic of the filtering for the pitch-absolute-value-signal filtering unit 6 only has to be a characteristic with which a probability of an error, which is unexpectedly caused in the pitch absolute value signal, causing mistake in judgment performed by the comparison unit 7, is sufficiently low. Note that, in general, it is satisfactory if the pass band characteristic of the pitch-absolute-value-signal filtering unit 6 is also a pass band characteristic of a secondary IIR type low-pass filter.

The comparison unit 7 judges, for respective boundaries, whether a boundary of sections for one pitch adjacent to each other in the pitch waveform data is a boundary of two phonemes different from each other (or an end of a sound), the middle of one phoneme, the middle of a frictional sound, or the middle of a silent state.

The judgment by the comparison unit 7 only has to be performed on the basis of the characteristics (a) and (b) described above inherent in a voice uttered by a human, for example, in accordance with the judgment conditions (1) to (4) described above. As a specific value of intensity of the pitch signal subjected to filtering, the comparison unit 7 only has to use, for example, a peak-to-peak value of an absolute value, an effective value, an average value of absolute values, or the like.

The comparison unit 7 divides the pitch waveform data in a boundary judged as the boundary of two phonemes different from each other (or an end of a sound) among boundaries of sections for one pitch adjacent to one another in the pitch waveform data. The comparison unit 7 supplies respective data obtained by dividing the pitch waveform data (i.e., phoneme data) to the output unit 8.

The output unit 8 includes, for example, a control circuit, which controls serial communication with the outside conforming to the standard of RS232C or the like, and a processor such as a CPU (and a memory that stores a program to be executed by this processor, etc.).

When the phoneme data generated by the comparison unit 7 and the sample number information generated by the pitch waveform extracting unit 2 are supplied, the output unit 8 generates a bit stream representing the phoneme data and the sample number information and outputs the bit stream.

The pitch waveform data divider in FIG. 6 also processes sound data having the waveform shown in FIG. 17(a) into pitch waveform data and, then, delimits the pitch waveform data at timing “t1” to timing “t19” shown in FIG. 5(a). In generating phoneme data using sound data having the waveform shown in FIG. 17(b), as shown in FIG. 5(b), the pitch waveform data divider selects a boundary “T0” of adjacent two phonemes as timing for delimiting correctly.

Consequently, respective phoneme data generated by the pitch waveform data divider in FIG. 6 are not phoneme data in which waveforms of plural phonemes are mixed. The respective phoneme data have accurate periodicity over the entire phoneme data. Therefore, if the pitch waveform data divider in FIG. 6 applies data compression by a method of the entropy coding to the generated phoneme data, this phoneme data is compressed efficiently.

Since the sound data is processed into the pitch waveform data, the influence of fluctuation in pitches is eliminated. Thus, it is less likely that an error occurs in the judgment performed by the comparison unit 7.

Moreover, it is possible to specify original time lengths of the respective sections of the pitch waveform data using the sample number information. Thus, it is possible to easily restore original sound data by restoring the time lengths of the respective sections of the pitch waveform data to time lengths in the original sound data.

Note that a constitution of this pitch waveform data divider is not limited to the one described above either.

For example, the sound input unit 1 may acquire sound data from the outside through a communication line such as a telephone line, a private line, or a satellite line. In this case, the sound input unit 1 only has to include a communication control unit consisting of, for example, a modem and a DSU.

The sound input unit 1 may include a sound collecting device consisting of a microphone, an AF amplifier, a sampler, an A/D converter, a PCM encoder, and the like. The sound collecting device only has to amplify a sound signal representing a sound collected by the own microphone and subject the sound signal to sampling and A/D conversion and, then, apply the PCM modulation to the sound signal subjected to sampling to thereby acquire sound data. Note that the sound data acquired by the sound input unit 1 is not always required to be a PCM signal.

The pitch waveform extracting unit 2 does not have to include the cepstrum analysis unit 201 (or the autocorrelation analysis unit 202). In this case, the weight calculating unit 203 only has to treat an inverse number of a basic frequency, which is calculated by the cepstrum analysis unit 201 (or the autocorrelation analysis unit 202), directly as an average pitch length.

The zero-cross analysis unit 206 may supply a pitch signal supplied from the band-pass filter 205 to the BPF coefficient calculating unit 204 directly as a zero-cross signal.

The output unit 8 may output phoneme data and sample number information to the outside through a communication line or the like. In outputting data through the communication line, the output unit 8 only has to include a communication control unit consisting of, for example, a modem and a DSU.

The output unit 8 may include a recording medium driving device. In this case, the output unit 8 may write phoneme data and sample number information in a storage area of a recording medium set in this recording medium driving device.

Note that a single mode, DSU, or recording medium driving device may constitute the sound input unit 1 and the output unit 8.

An amount, with which the phase adjusting unit 208 phase-shifts sound data in respective sections of sound data, does not always have to be (−ψ). A position, where the waveform correlation analysis unit 207 delimits sound data, does not always have to be timing when a pitch signal crosses zero.

The interpolation unit 209 does not always have to perform interpolation of phase-shifted sound data with the method of the Lagrange's interpolation. For example, the interpolation unit 209 may perform the interpolation of phase-shifted sound data with a method of linear interpolation. It is also possible that the interpolation unit 209 is not provided and the phase adjusting unit 208 supplies sound data to the pitch length adjusting unit 210 immediately.

The comparison unit 7 may generate and output information specifying which one of phoneme data represents a frictional sound and a silent state.

The comparison unit 7 may apply the entropy coding to the generated phoneme data and, then, supply the phoneme data to the output unit 8.

### Third Embodiment

Next, a synthesized sound using system according to a third embodiment of the invention will be explained.

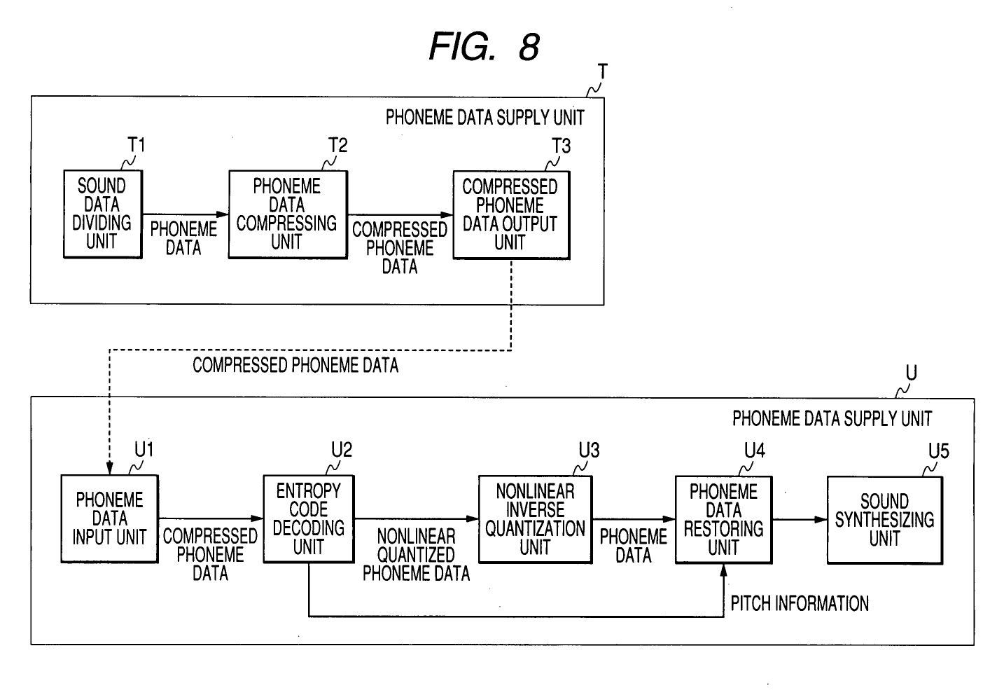

FIG. 8 is a diagram showing a constitution of this synthesized sound using system. As shown in the figure, the synthesized sound using system includes a phoneme data supply unit T and a phoneme data using unit U. The phoneme data supply unit T generates phoneme data, applies data compression to the phoneme data, and outputs the phoneme data as compressed phoneme data described later. The phoneme data using unit U inputs the compressed phoneme data outputted by the phoneme data supply unit T to restore the phoneme data and performs sound synthesis using the restored phoneme data.

As shown in FIG. 8, the phoneme data supply unit T includes, for example, a sound data dividing unit T1, a phoneme data compressing unit T2, and a compressed phoneme data output unit T3.

The sound data dividing unit T1 has, for example, a constitution substantially identical with that of the pitch waveform data divider according to the first or the second embodiment described above. The sound data dividing unit T1 acquires sound data from the outside and processes this sound data into pitch waveform data. Then, the sound data dividing unit T1 divides the pitch waveform data into a set of sections equivalent to one phoneme to thereby generate the phoneme data and pitch information (sample number information) and supplies the phoneme data and the pitch information to the phoneme data compressing unit T2.

The phoneme data dividing unit T1 may acquire information representing a sentence read out by the sound data used for the generation of the phone data, convert this information into a phonogram string representing a phoneme with a publicly-known method, and adds (labels) respective phonograms included in the obtained phonogram string to phoneme data representing phonemes for reading out the phonograms.

Both the phoneme data compressing unit T2 and the compressed phoneme data output unit T3 include a processor such as a DSP or a CPU and a memory storing a program to be executed by the processor. Note that a single processor may carry out a part or all of functions of the phoneme data compressing unit T2 and the compressed phoneme data output unit T3. A processor carrying out a function of the sound data dividing unit T1 may further carry out a part or all of the functions of the phoneme data compressing unit T2 and the compressed phoneme data output unit T3.

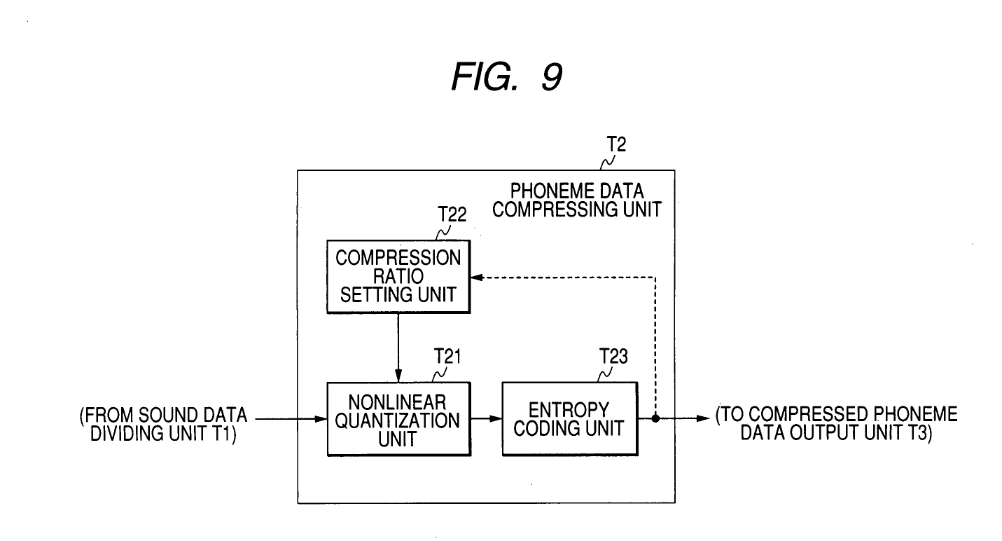

As shown in FIG. 9, functionally, the phoneme data compressing unit T2 includes a nonlinear quantization unit T21, a compression ratio setting unit T22, and an entropy coding unit T23.

When phoneme data is supplied from the sound data dividing unit T1, the nonlinear quantization unit T21 generates nonlinear quantized phoneme data equivalent to a quantized value of a value obtained by applying nonlinear compression to an instantaneous value of a waveform represented by this phoneme data (specifically, for example, a value obtained by substituting the instantaneous value in a convex function). The nonlinear quantization unit T21 supplies the generated nonlinear quantized phoneme data to the entropy coding unit T23.

Note that it is assumed that the nonlinear quantization unit T21 acquires compression characteristic data for specifying a correspondence relation between a value before compression and a value after compression of the instantaneous value from the compression ratio setting unit T22 and performs compression in accordance with the correspondence relation specified by this data.

Specifically, for example, the nonlinear quantization unit T21 acquires data specifying a function global_gain(xi) included in a right part of formula 4 from the compression ratio setting unit T22 as compression characteristic data. The nonlinear quantization unit T21 changes instantaneous values of respective frequency components after nonlinear compression to values substantially equal to a value obtained by quantizing a function Xri(xi) shown in the right part of formula 4 to thereby perform the nonlinear quantization.
Xri(xi)=sgn(xi)·|xi|4/3·2^{{global}^{_{—}}^{gain(xi)}/4} (Formula 4)
(where, sgn(α)=(α/|α|), xi is an instantaneous value of a waveform represented by phoneme data, global_gain(xi) is a function of xi for setting a full scale)

The compression ratio setting unit T22 generates the compression characteristic data for specifying a correspondence relation between a value before compression and a value after compression of an instantaneous value by the nonlinear quantization unit T21 (hereinafter referred to as compression characteristic) and supplies the compression characteristic data to the nonlinear quantization unit T21 and the entropy coding unit E23. Specifically, for example, the compression ratio setting unit T22 generates compression characteristic data specifying the function global_gain(xi) and supplies the compression characteristic data to the nonlinear quantization unit T21 and the entropy coding unit T23.

Note that, in order to determine a compression characteristic, for example, the compression ratio setting unit T22 acquires compressed phoneme data from the entropy coding unit T23. The compression ratio setting unit T22 calculates a ratio of a data amount of the compressed phoneme data, which is acquired from the entropy coding unit 23, to a data amount of the phoneme data, which is acquired from the sound data dividing unit T1, and judges whether the calculated ratio is larger than a target predetermined compression ratio (e.g., about 1/100). When it is judged that the calculated ratio is larger than the target compression ratio, the compression ratio setting unit T22 determines a compression characteristic such that a compression ratio becomes smaller than a present compression ratio. On the other hand, when it is judged that the calculated ratio is equal to or smaller than the target compression ratio, the compression ratio setting unit T22 determines a compression characteristic such that a compression ratio becomes larger than a present compression ratio.

The entropy coding unit T23 subjects the nonlinear quantized phoneme data supplied from the nonlinear quantization unit T21, the pitch information supplies from the sound data dividing unit T1, and the compression characteristic data supplied from the compression ratio setting unit T22 to the entropy coding (specifically, for example, converts the data into an arithmetic code or a Huffman code). The entropy coding unit T23 supplies the data subjected to the entropy coding to the compression ratio setting unit T22 and the compressed phoneme data output unit T3 as compressed phoneme data.

The compressed phoneme data output unit T3 outputs the compressed phoneme data supplied from the entropy coding unit T23. A method of outputting the compressed phone data is arbitrary. For example, the compressed phoneme data output unit T3 may record the compressed phoneme data in a computer readable recording medium (e.g., a CD (Compact Disc), a DVD (Digital Versatile Disc), a flexible disc, etc.) or may serially transmit the compressed phoneme data in a form conforming to the standards of Ethernet (registered trademark), USB (Universal Serial bus), IEEE1394, RS232C, or the like. Alternatively, the compressed phoneme data output unit T3 may transmits the compressed phoneme data in parallel. Moreover, the compressed phoneme data output unit T3 may deliver the compressed phoneme data with a method of, for example, uploading the compressed phoneme data to an external server through a network such as the Internet.

In recording the compressed phoneme data in the recording medium, the compressed phoneme data output unit T3 only has to further include a recording medium driving device that performs writing of data in the recording medium in accordance with an instruction of a processor or the like. In transmitting the compressed phoneme data serially, the compressed phoneme data output unit T3 only has to further include a control circuit that controls serial communication with the outside conforming to the standards of Ethernet (registered trademark), USB, IEEE1394, RS232C, or the like.

The phoneme data using unit U includes, as shown in FIG. 8, a compressed phoneme data input unit U1, an entropy coding/decoding unit U2, a nonlinear inverse quantization unit U3, a phoneme data restoring unit U4, and a sound synthesizing unit U5.

All of the compressed phoneme data input unit U1, the entropy coding/decoding unit U2, the nonlinear inverse quantization unit U3, and the phoneme data restoring unit U4 include a processor such as a DSP or a CPU and a memory storing a program to be executed by this processor. Note that a single processor may carry out a part or all of functions of the compressed phoneme data input unit U1, the entropy coding/decoding unit U2, the nonlinear inverse quantization unit U3, and the phoneme data restoring unit U4.

The compressed phoneme data input unit U1 acquires the compressed phoneme data from the outside and supplies the acquired compressed phoneme data to the entropy coding/decoding unit U2. A method with which the compressed phoneme data input unit U1 acquires compressed phoneme data is arbitrary. For example, the compressed phoneme data input unit U1 may acquire compressed phoneme data recorded in a computer readable recording medium by reading the compressed phoneme data. Alternatively, the compressed phoneme data input unit U1 may acquire compressed phoneme data serially transmitted in a form conforming to the standards of Ethernet (registered trademark), USB, IEEE1394, RS232C, or the like or compressed phoneme data transmitted in parallel by receiving the compressed phoneme data. The compressed phoneme data input unit U1 may acquire compressed phoneme data stored by an external server with a method of, for example, downloading the compressed phoneme data through a network such as the Internet.

Note that, in reading compressed phoneme data from a recording medium, the compressed phoneme data input unit U1 only has to further include, for example, a recording medium driving device that performs reading of data from the recording medium in accordance with an instruction of a processor or the like. In receiving compressed phoneme data serially transmitted, the compressed phoneme data input unit U1 only has to further include a control circuit that controls serial communication with the outside conforming to the standards such as Ethernet (registered trademark), USB, IEEE1394, RS232C, or the like.

The entropy coding/decoding unit U2 decodes the compressed phoneme data (i.e., the nonlinear quantized phoneme data, the pitch information, and the compression characteristic data subjected to the entropy coding) supplied from the compressed phoneme data input unit U1 to thereby restore the nonlinear quantized phoneme data, the pitch information, and the compression characteristic data. The entropy coding/decoding unit U2 supplies the restored nonlinear quantized phoneme data and compression characteristic data to the nonlinear inverse quantization unit U3 and supplies the restored pitch information to the phoneme data restoring unit U4.

When the nonlinear quantized phoneme data and the compression characteristic data are supplied from the entropy coding/decoding unit U2, the nonlinear inverse quantization unit U3 changes an instantaneous value of a waveform represented by this nonlinear quantized phoneme data in accordance with a characteristic, which is in a relation of inverse conversion with a compression characteristic indicated by this compression characteristic data, to thereby restore the phoneme data before being subjected to the nonlinear quantization. The nonlinear inverse quantization unit U3 supplies the restored phoneme data to the phoneme data restoring unit U4.

The phoneme data restoring unit U4 changes time lengths of respective sections of the phoneme data supplied from the nonlinear inverse quantization unit U3 to be time lengths indicated by the pitch information supplied from the entropy coding/decoding unit U2. The phoneme data restoring unit U4 only has to change the time lengths of the sections by changing intervals of samples in the sections and/or the number of samples.

The phoneme data restoring unit U4 supplies the phoneme data with the time lengths of the respective sections changed, that is, the restored phoneme data to a waveform database U506 described later of the sound synthesizing unit U5.

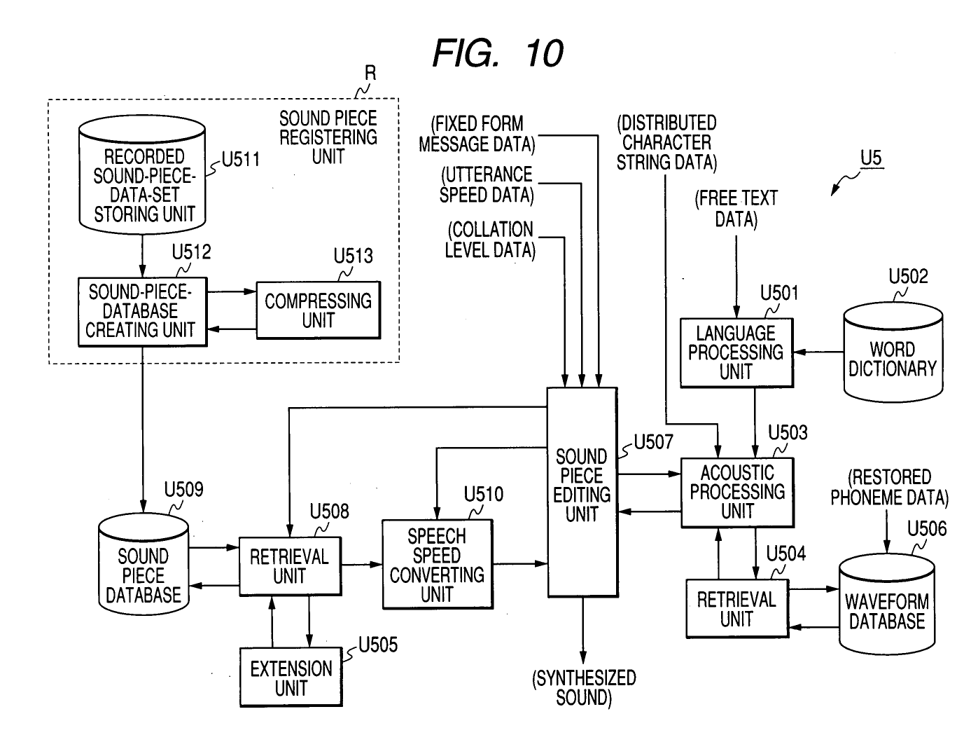

The sound synthesizing unit U5 includes, as shown in FIG. 10, a language processing unit U501, a word dictionary U502, an acoustic processing unit U503, a retrieval unit U504, an extension unit U505, a waveform database U506, a sound piece editing unit U507, a retrieval unit U508, a sound piece database U509, a speech speed converting unit U510, and a sound piece registering unit R.

All of the language processing unit U501, the acoustic processing unit U503, the retrieval unit U504, the extension unit U505, the sound piece editing unit U507, the retrieval unit U508, and the speech speed converting unit U510 include a processor such as a CPU and a DSP and a memory storing a program to be executed by this processor and performs processing described later, respectively.

Note that a single processor may carry out a part or all of functions of the language processing unit U501, the acoustic processing unit U503, the retrieval unit U504, the extension unit U505, the sound piece editing unit U507, the retrieval unit U508, and the speech speed converting unit U510. A processor carrying out the function of the compressed phoneme data input unit U1, the entropy coding/decoding unit U2, the nonlinear inverse quantization unit U3, or the phoneme data restoring unit U4 may further carry out a part or all of the functions of the language processing unit U501, the acoustic processing unit U503, the retrieval unit U504, the extension unit U505, the sound piece editing unit U507, the retrieval unit U508, and the speech speed converting unit U510.

The word dictionary U502 includes a data-rewritable nonvolatile memory such as an EEPROM (Electrically Erasable/Programmable Read Only Memory) or a hard disk device and a control circuit that controls writing of data in this nonvolatile memory. Note that a processor may carry out a function of this control circuit. A processor carrying out a part or all of the functions of the compressed phoneme data input unit U1, the entropy coding/decoding unit U2, the nonlinear inverse quantization unit U3, the phoneme data restoring unit U4, the language processing unit 501, the acoustic processing unit U503, the retrieval unit U504, the extension unit U505, the sound piece editing unit U507, the retrieval unit U508, and the speech speed converting unit U510 may carry out the function of the control circuit of the word dictionary U502.

In the word dictionary U502, words and the like including ideograms (e.g., kanji) and phonograms (e.g., kana and phonetic symbols) representing reading of the words and the like in association with each other in advance by a manufacturer or the like of this sound synthesizing system. The word dictionary 53 acquires the words and the like including ideograms and the phonograms representing reading of the words and the like from the outside in accordance with operation of a user and stores the words and the like and the phonograms in association with each other. Note that a portion storing data stored in advance of the nonvolatile constituting the word dictionary U502 may be constituted by an un-rewritable nonvolatile memory such as a PROM (Programmable Read Only Memory).

The waveform database U506 includes a data-rewritable nonvolatile memory such as an EEPROM or a hard disc device and a control circuit that controls writing of data in this nonvolatile memory. Note that a processor may carry out a function of this control circuit. A processor carrying out a part or all of the functions of the compressed phoneme data input unit U1, the entropy coding/decoding unit U2, the nonlinear inverse quantization unit U3, the phoneme data restoring unit U4, the language processing unit 501, the word dictionary U502, the acoustic processing unit U503, the retrieval unit U504, the extension unit U505, the sound piece editing unit U507, the retrieval unit U508, and the speech speed converting unit U510 may carry out the function of the control circuit of the waveform database U506.

In the waveform database U506, phonograms and phoneme data representing waveforms of phonemes represented by the phonographs are stored in association with each other in advance by the manufacture or the like of this sound synthesizing system. The waveform database U506 stores the phoneme data supplied from the phoneme data restoring unit U4 and the phonograms representing phonemes represented by waveforms of the phoneme data in association with each other. Note that a portion storing data stored in advance of the nonvolatile memory constituting the waveform database U506 may be constituted by an un-rewritable nonvolatile memory such as a PROM.

Note that the waveform database U506 may store data representing a sound delimited by a unit such as a VCV (Vowel-Consonant-Vowel) syllable together with the phoneme data.

The sound piece database U509 is constituted by a data-rewritable nonvolatile memory such as an EEPROM or a hard disk device.

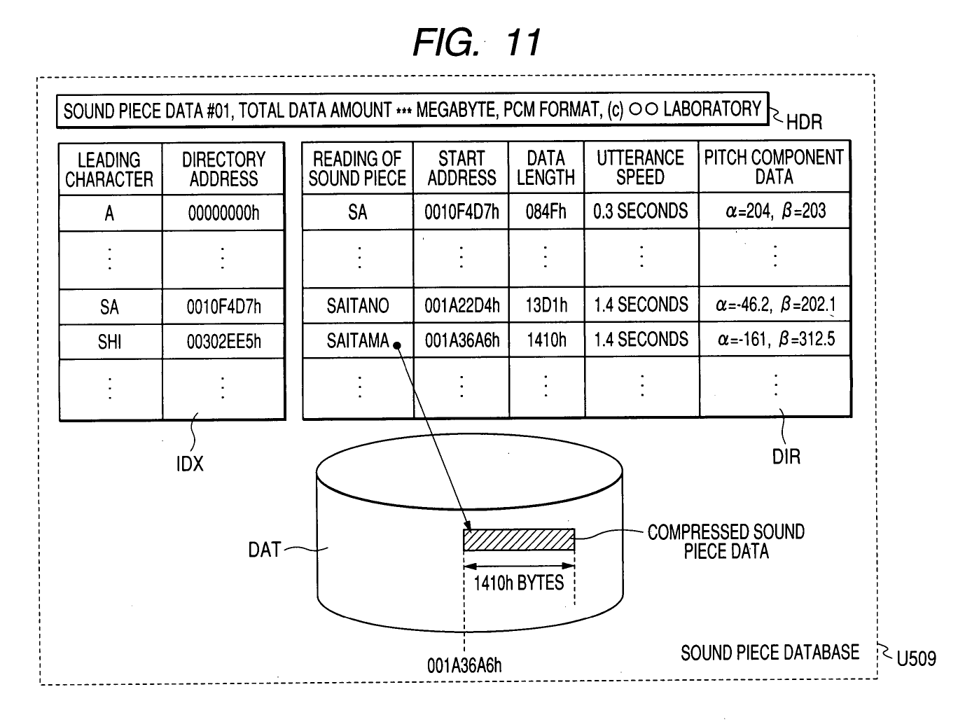

In the sound piece database U509, for example, data having a data structure shown in FIG. 11 is stored. In other words, as shown in the figure, the data stored in the sound piece database U509 is divided into four types, namely, a header section HDR, an index section IDX, a directory section DIR, and a data section DAT.

Note that the manufacturer of this sound synthesizing system stores data in the sound piece database U509 in advance and/or the sound piece registering unit R stores data by performing an operation described later. Note that a portion storing data stored in advance of the nonvolatile memory constituting the sound piece database U509 may be constituted by an un-rewritable nonvolatile memory such as a PROM.

In the header unit HDR, data identifying the sound piece database U509 and data indicating data mounts of the index section IDX, the directory section DIR, and the data section DAT, formats of the data, and attribution of a copyright and the like are stored.

In the data section DAT, compressed sound piece data obtained by subjecting sound piece data representing waveforms of sound pieces to the entropy coding is stored.

Note that a sound piece refers to continuous one section including one or more phonemes of a sound. Usually, the sound piece consists of a section for one word or plural words.

Sound piece data before being subjected to the entropy coding only has to consist of data of the same format as the phoneme data (e.g., data of a digital format subjected to the PCM).

In the directory section DIR, for respective compressed sound data, the following data are stored in association with one another (note that it is assumed that an address is attached to a storage area of the sound piece database U509):

(A) data representing phonograms indicating reading of a sound piece represented by this compressed sound piece data (sound piece reading data);

(B) data representing a starting address of a storage position where this compressed sound piece data is stored;

(C) data representing a data length of this compressed sound piece data;

(D) data representing an utterance speed of the sound piece represented by this compressed sound piece data (a time length at the time when the compressed sound piece data is reproduced) (speed initial value data); and

(E) data representing a change over time of a frequency of a pitch component of this sound piece (pitch component data).

Note that FIG. 11 illustrates a case in which compressed sound piece data with a data amount of 1410h bytes representing a waveform of a sound piece with reading “saitama” is stored in a logical position starting with an address 001A36A6h as data included in the data section DAT. (Note that, in this specification and the drawings, numerals attached with “h” at the end represent hexadecimal numbers.)

At least the data (A) (i.e., sound piece reading data) of a set of data (A) to (E) is stored in an storage area of the sound piece database U509 in a state in which the data is sorted in accordance with an order determined on the basis of phonograms represented by the sound piece reading data (e.g., if the phonograms are kana, in a state in which the data is arranged in a descending order of addresses in accordance with a kana syllabary order).

For example, as shown in the figure, the pitch component data only has to consist of, in the case in which a frequency of a pitch component of a sound piece is approximated by a linear function of elapsed time from a top of the sound piece, data indicating values of a section β and a gradient a of this linear function. (A unit of the gradient a only has to be, for example, [hertz/second] and a unit of the section β only has to be, for example, [hertz].) It is assumed that not-shown data representing whether a sound piece represented by compressed sound piece data is changed to a nosal voice and whether the sound piece is changed to silence is also included in the pitch component data.

In the index section IDX, data for specifying a rough logical position of data in the directory section DIR on the basis of sound piece reading data. Specifically, for example, assuming that the sound piece reading data represents kana, a kana character and data indicating in an address of which range sound piece reading data starting with this kana character is present (a directory address) are stored in association with each other.

Note that a single nonvolatile memory may carry out a part or all of functions of the word dictionary U502, the waveform database U506, and the sound piece database U509.

As shown in the figure, the sound piece registering unit R includes a recorded sound-piece-dataset storing unit U511, a sound-piece-database creating unit U512, and a compressing unit U513. Note that the sound piece registering unit R may be detachably connected to the sound piece database U509. In this case, except the time when data is written in the sound piece database U509 anew, a main body unit M may be caused to perform an operation described later in a state in which the sound piece registering unit R is detached from the main body unit M.

The recorded sound-piece-dataset storing unit U511 is constituted by a data-rewritable nonvolatile memory such as a hard disk device and is connected to the sound-piece-database creating unit U512. Note that the recorded sound-piece-dataset storing unit U511 may be connected to the sound-piece-database creating unit U512 through a network.

In the recorded sound-piece-dataset storing unit U511, phonograms representing reading of sound pieces and sound piece data representing waveforms obtained by collecting the sound pieces actually uttered by a human are stored in association with each other in advance by the manufacturer or the like of this sound synthesizing system. Note that this sound piece data only has to consist of, for example, data of a digital format subjected to the PCM.

The sound-piece-database creating unit U512 and the compressing unit U513 include a processor such as a CPU and a memory storing a program to be executed by this processor. The sound-piece-database creating unit U512 and the compressing unit U513 performs processing described later in accordance with this program.

Note that a single processor may carry out a part or all of functions of the sound-piece-database creating unit U512 and the compressing unit U513. A processor carrying out a part or all of functions of the compressed phoneme data input unit U1, the entropy coding/decoding unit U2, the nonlinear inverse quantization unit U3, the phoneme data restoring unit U4, the language processing unit U501, the acoustic processing unit U503, the retrieval unit U504, the extension unit U505, the sound piece editing unit U507, the retrieval unit U508, and the speech speed converting unit U510 may further carry out the functions of the sound-piece-database creating unit U512 and the compressing unit U513. The processor carrying out the functions of the sound-piece-database creating unit U512 and the compressing unit U513 may also carry out a function of the control circuit of the recorded sound-piece-dataset storing unit U511.

The sound-piece-database creating unit U512 reads out the phonograms and the sound piece data associated with each other from the recorded sound-piece-dataset storing unit U511 and specifies a change over time of a frequency of a pitch component of a sound represented by this sound piece data and utterance speed. Note that the sound-piece-database creating unit U512 only has to specify utterance speed by counting the number of samples of this sound piece data.

On the other hand, the sound-piece-database creating unit U512 only has to specify a change over time of a frequency of a pitch component by, for example, applying the cepstrum analysis to this sound piece data. Specifically, for example, the sound-piece-database creating unit U512 delimits a waveform represented by sound piece data into a large number of small portions on a time axis and converts intensity of each of the small portions obtained into a value substantially equal to a logarithm of an original value (a base of the logarithm is arbitrary). The sound-piece-database creating unit U512 calculates a spectrum (i.e., cepstrum) of this small portion with a value converted with the method of the fast Fourier transform (or other arbitrary methods of generating data representing a result obtained by subjecting a discrete variable to the Fourier transform). The sound-piece-database creating unit U512 specifies a minimum value among frequencies giving a maximum value of this cepstrum as a frequency of a pitch component in this small portion.

Note that, as the change over time of a frequency of a pitch component, a satisfactory result can be expected if, for example, the sound-piece-database creating unit U512 converts sound piece data into pitch waveform data with the pitch waveform data divider according to the first or the second embodiment or a method substantially identical with the method performed by the sound data dividing unit T1 and, then, specifies the change over time on the basis of this pitch waveform data. Specifically, the sound-piece-database creating unit U512 only has to convert the sound piece data into a pitch waveform signal by subjecting the sound piece data to filtering to extract a pitch signal, delimiting a waveform represented by the sound piece data into sections of a unit pitch length on the basis of the extracted pitch signal, and, for the respective sections, specifying deviation of a phase on the basis of a correlation with the pitch signal to make phases of the respective sections uniform. The sound-piece-database creating unit U512 only has to specify a change over time of a frequency of a pitch component by, for example, treating the obtained pitch waveform signal as sound piece data and performing the cepstrum analysis.

On the other hand, the sound-piece-database creating unit U512 supplies the sound piece data read out from the recorded sound-piece-database storing unit U511 to the compressing unit U513.

The compressing unit U513 subjects the sound piece data supplied from the sound piece data creating unit U512 to the entropy coding to create compressed sound piece data and returns the compressed sound piece data to the sound-piece-database creating unit U512.

When the utterance speed of the sound piece data and the change over time of a frequency of a pitch component are specified and the sound piece data is subjected to the entropy coding to be compressed sound piece data and returned from the compressing unit U513, the sound-piece-database creating unit U512 writes this compressed sound piece data in the storage area of the sound piece database U509 as data constituting the data section DAT.

The sound-piece-database creating unit U512 writes the phonograms, which are read out from the recorded sound-piece-dataset storing unit U511 as characters indicating reading of a sound piece represented by the written compressed sound piece data, in the storage area of the sound piece database U509 as sound piece reading data.

The sound-piece-database creating unit U512 specifies a starting address of the written compressed sound piece data in the storage area of the sound piece database U509 and writes this address in the storage area of the sound piece database U509 as the data (B).

The sound-piece-database creating unit U512 specifies a data length of this compressed sound piece data and writes the specified data length in the storage area of the sound piece database U509 as the data (C).

The sound-piece-database creating unit U512 generates data indicating a result of specifying utterance speed of a sound piece represented by this compressed sound piece data and a change over time of a frequency of a pitch component and writes the data in the storage area of the sound piece database U509 as speed initial value data and pitch component data.

Next, operations of the sound synthesizing unit U5 will be explained. First, it is assumed that the language processing unit U501 has acquired free text data describing a sentence (a free text) including ideograms, which is prepared by a user as an object with which a sound is synthesized by the sound synthesizing system, from the outside.

Note that a method with which the language processing unit U501 acquires free text data is arbitrary. For example, the language processing unit U501 may acquire free text data from an external apparatus or a network via a not-shown interface circuit. The language processing unit U501 may read free text data from a recording medium (e.g., a floppy (registered trademark) disc or a CD-ROM), which is set in a not-shown recording medium driving device, via this recording medium driving device. A processor carrying out a function of the language processing unit U501 may pass text data, which is used in other processing executed by the processor, to processing of the language processing unit U501 as free text data.

When the free text data is acquired, the language processing unit U501 specifies phonograms representing reading of each of ideograms included in the free text by searching through the word dictionary U502. The language processing unit U501 replaces the ideogram with the specified phonogram. The language processing unit U501 supplies a phonogram string, which is obtained as a result of replacing all the ideograms in the free text with phonograms, to the acoustic processing unit U503.

When the phonogram string is supplied form the language processing unit U501, the acoustic processing unit U503 instructs the retrieval unit U504 to retrieve, for each of phonograms included in this phonogram string, a waveform of a unit sound represented by the phonogram.

The retrieval unit U504 searches through the waveform database U506 in response to this instruction and retrieves phoneme data representing a waveform of a unit sound represented by each of the phonograms included in the phonogram string. The retrieval unit U504 supplies the retrieved phoneme data to the acoustic processing unit U503 as a result of the retrieval.

The acoustic processing unit U503 supplies the phoneme data supplied from the retrieval unit U504 to the sound piece editing unit U507 in an order complying with an arrangement of the respective phonograms in the phonogram string supplied from the language processing unit U501.

When the phoneme data is supplied from the acoustic processing unit U503, the sound piece editing unit U507 combines the phoneme data with one another in the order of supply and outputs the combined phoneme data as data representing a synthesized sound (synthesized sound data). This synthesized sound, which is synthesized on the basis of the free text data, is equivalent to a sound synthesized by a method of a rule-based synthesis system.

Note that a method with which the sound piece editing unit U507 outputs the synthesized sound data is arbitrary. For example, the sound piece editing unit U507 may reproduce a synthesized sound represented by this synthesized sound data via a not-shown D/A (Digital-to-Analog) converter and a not-shown speaker. The sound piece editing unit U507 may send the synthesized sound data to an external apparatus or a network via a not-shown interface circuit or may write the synthesized sound data in a recording medium, which is set in a not-shown recording medium driving device, via this recording medium driving device. A processor carrying out a function of the sound piece editing unit U507 may pass the synthesized sound data to other processing executed by the processor.

Next, it is assumed that the acoustic processing unit U503 has acquired data representing a phonogram string distributed from the outside (distributed character string data). (Note that a method with which the acoustic processing unit U503 acquires distributed character string data is also arbitrary. For example, the acoustic processing unit U503 only has to acquire distributed character string data with a method same as the method with which the language processing unit U501 acquires free text data.)

In this case, the acoustic processing unit U503 treats a phonogram string represented by the distributed character string data in the same manner as the phonogram string supplied from the language processing unit U501. As a result, phoneme data corresponding to phonograms included in the phonogram string represented by the distributed character string data is retrieved by the retrieval unit U504. The retrieved respective phoneme data is supplied to the sound piece editing unit U507 via the acoustic processing unit U503. The sound piece editing unit U507 combines the phoneme data with one another in an order complying with arrangement of respective phonograms in the phonogram string represented by the distributed character string data and outputs the combined phoneme data as synthesized sound data. This synthesized sound data, which is synthesized on the basis of the distributed character string data, also represents a sound synthesized by the method of the rule-based synthesis system.

Next, it is assumed that the sound piece editing unit U507 has acquired fixed form message data, utterance speed data, and collation level data.

Note that the fixed form message data is data representing a fixed form message as a phonogram string. The utterance speed data is data indicating a designated value of utterance speed of the fixed form message represented by the fixed form message data (a designated value of a time length of utterance of this fixed form message). The collation level data is data designating a retrieval condition in retrieval processing described later that is performed by the retrieval unit U508. In the following description, it is assumed that the retrieval condition takes a value of “1”, “2”, or “3” and the value “3” indicates a most strict retrieval condition.

A method with which the sound piece editing unit U507 acquires fixed form message data, utterance speed data, and collation level data is arbitrary. For example, the sound piece editing unit U507 only has to acquire fixed form message data, utterance speed data, and collation level data with a method same as the method with which the language processing unit U501 acquires free text data.

When the fixed form message data, the utterance speed data, and the collation level data are supplied to the sound piece editing unit U507, the sound piece editing unit U507 instructs the retrieval unit U508 to retrieve all compressed sound piece data to which phonograms matching phonograms representing reading of sound pieces included in the fixed form message are associated.

The retrieval unit U508 searches through the sound piece database U509 in response to the instruction of the sound piece editing unit U507. The retrieval unit U508 retrieves corresponding compressed sound piece data and the sound piece reading data, the speed initial value data, and the pitch component data associated with the corresponding compressed sound piece data and supplies the retrieved compressed sound piece data to the extension unit U505. When plural compressed sound piece data correspond to one sound piece, all corresponding compressed sound piece data are retrieved as candidates of data used for sound synthesis. On the other hand, when there is a sound piece for which compressed sound piece data cannot be retrieved, the retrieval unit U508 generates data identifying the sound piece (hereinafter referred to as lacked part identification data).

The extension unit U505 restores the compressed sound piece data supplied from the retrieval unit U508 to sound piece data before being compressed and returns the sound piece data to the retrieval unit U508. The retrieval unit U508 supplies the sound piece data returned from the extension unit U505 and the retrieved sound piece reading data, speed initial value data, and the pitch component data to the speech speed converting unit U510 as a result of the retrieval. When the lacked part identification data is generated, the extension unit U505 also supplies this lacked part identification data to the speech speed converting unit U510.

On the other hand, the sound piece editing unit U507 instructs the speech speed converting unit U510 to convert the sound piece data supplied to the speech speed converting unit 510 such that a time length of a sound piece represented by the sound piece data matches speed indicated by the utterance speed data.

The speech speed converting unit U510 responds to the instruction of the sound piece editing unit U507, converts the sound piece data supplied from the retrieval unit U508 to match the instruction, and supplies the sound piece data to the sound piece editing unit U507. Specifically, for example, the speech speed converting unit U510 only has to specify an original time length of the sound piece data supplied from the retrieval unit U508 on the basis of the retrieved speed initial value data and, then, subject this sound piece data to re-sampling, and convert the number of samples of this sound piece data into a time length matching speed instructed by the sound piece editing unit U507.

The speech speed converting unit U510 also supplies the sound piece reading data and the pitch component data, which are supplied from the retrieval unit U508, to the sound piece editing unit U507. When the lacked part identification data is supplied from the retrieval unit U508, the speech speed converting unit U510 also supplies this lacked part identification data to the sound piece editing unit U507.

Note that, when utterance speed data is not supplied to the sound piece editing unit U507, the sound piece editing unit U507 only has to instruct the speech speed converting unit U510 to supply the sound piece data, which is supplied to the speech speed converting unit U510, to the sound piece editing unit U507 without converting the sound piece data. The speech speed converting unit U510 only has to supply the sound piece data, which is supplied from the retrieval unit U508, to the sound piece editing unit U507 directly in response to this instruction.

When the sound piece data, the sound piece reading data, and the pitch component data are supplied from the speech speed converting unit U510, the sound piece editing unit U507 selects one sound piece data representing a waveform, which can be approximated to a waveform of sound pieces constituting the fixed form message, for one sound piece out of the supplied sound piece data. However, the sound piece editing unit U507 sets a condition, which is satisfied by a waveform set to be a waveform close to the sound pieces of the fixed form message, in accordance with the acquired collation level data.

Specifically, first, the sound piece editing unit U507 applies analysis based on a method of rhythm prediction such as “Fujisaki model” or “ToBI (Tone and Break Indices)” to the fixed form message to thereby predict a rhythm (accent, intonation, stress, etc.) of this fixed form message.

Next, for example, the sound piece editing unit U507 selects sound piece data close to the waveform of the sound pieces in the fixed form message as described below.

(1) When a value of the collation level data is “1”, the sound piece editing unit U507 selects all the sound piece data (i.e., sound piece data, reading of which matches the sound pieces in the fixed form message) supplied from the speech speed converting unit U510 as sound piece data close to the waveform of the sound pieces in the fixed form message.

(2) When a value of the collation level data is “2”, only when the condition (1) (i.e., the condition of matching of phonograms representing reading) is satisfied and there is strong correlation equal to or higher than a predetermined amount between contents of the pitch component data representing a change over time of a frequency of a pitch component of the sound piece data and a result of prediction of accent of the sound pieces included in the fixed form message (e.g., when a time difference of positions of accent is equal to or lower than the predetermined value), the sound piece editing unit U507 selects this sound piece data as sound piece data close to the waveform of the sound pieces in the fixed form message. Note that a result of prediction of accent of the sound pieces in the fixed form message can be specified from a result of prediction of a rhythm of the fixed form message. For example, the sound piece editing unit U507 only has to interpret that a position predicted as having a highest frequency of the pitch component is a predicted position of accent. On the other hand, concerning a position of accent of a sound piece represented by the sound piece data, the sound piece editing unit U507 only has to specify a position where a frequency of the pitch component is the highest on the basis of the pitch component data and interpret this position as a position of accent.

(3) When a value of the collation level data is “3”, only when the condition (2) (i.e., the condition of matching of phonograms representing reading and accent) is satisfied and presence or absence of the change of a sound represented by the sound piece data to a nosal voice or silence matches a result of prediction of a rhythm of the fixed form message, the sound piece editing unit U507 selects this sound piece data as sound piece data close to the waveform of the sound pieces in the fixed form message. The sound piece editing unit U507 only has to judge presence or absence of the change of a sound represented by the sound piece data to a nosal voice or silence on the basis of the pitch component data supplied from the speech speed converting unit U510.

Note that, when there are plural sound piece data matching a condition, which is set by the sound piece editing unit U507, for one sound piece, the sound piece editing unit U507 narrows down the plural sound piece data to one sound piece data in accordance with a condition more strict than the set condition.

Specifically, the sound piece editing unit U507 performs operation as described below. For example, when the set condition is equivalent to the value “1” of the collation level data and there are plural corresponding sound piece data, the sound piece editing unit U507 selects sound piece data matching a retrieval condition equivalent to the value “2” of the collation level data. When plural sound piece data are still selected, the sound piece editing unit U507 further selects sound piece data also matching a retrieval condition equivalent to the value “3” of the collation level data out of the result of selection. When plural sound piece data still remain even after the sound piece data are narrowed down according to the retrieval condition equivalent to the value “3” of the collation level data, the sound piece editing unit U507 only has to narrow down the remaining sound piece data to one sound piece data according to an arbitrary standard.

On the other hand, when the lacked part identification data is also supplied from the speech speed converting unit U510, the sound piece editing unit U507 extracts a phonogram string representing reading of a sound piece indicated by the lacked part identification data from the fixed form message data, supplies the phonogram string to the acoustic processing unit U503, and instructs the acoustic processing unit U503 to synthesize a waveform of this sound piece.

The instructed acoustic processing unit U503 treats the phonogram character string supplied from the sound piece editing unit U507 in the same manner as the phonogram string represented by the distributed character string data. As a result, phoneme data representing a waveform of a sound indicated by phonograms included in this phonogram string is retrieved by the retrieval unit U504. This phoneme data is supplied from the retrieval unit U504 to the acoustic processing unit U503. The acoustic processing unit U503 supplies this phoneme data to the sound piece editing unit U507.

When the phoneme data is returned from the acoustic processing unit U503, the sound piece editing unit U507 combines this phoneme data and the sound piece data, which is selected by the sound piece editing unit U507, among the sound piece data supplied from the speech speed converting unit U510 each other in an order complying with arrangement of the respective sound pieces in the fixed form message indicated by the fixed message data. The sound piece editing unit U507 outputs the combined data as data representing a synthesized sound.

Note that, when lacked part identification data is not included in the data supplied from the speech speed converting unit U510, the sound piece editing unit U507 only has to combine the sound piece data selected by the sound piece editing unit U507 in an order complying with arrangement of the respective sound pieces in the fixed form message indicated by the fixed form message data immediately without instructing the acoustic processing unit U503 to synthesize waveforms and output the combined data as data representing a synthesized sound.

Note that a constitution of this synthesized sound using system is not limited to the one described above.

For example, the sound piece database U509 does no always have to store sound piece data in a state in which the sound piece data are compressed. When the sound piece database U509 stores waveform data and sound piece data in a state in which the waveform data and the sound piece data are not compressed, the sound synthesis unit U5 does not have to include the extension unit U505.

On the other hand, the waveform database U506 may store phoneme data in a state in which the phoneme data is compressed. When the waveform database U506 stores the phoneme data in a state in which the phoneme data is compressed, the extension unit U505 only has to acquire phoneme data, which is retrieved by the retrieval unit U504 from the waveform database U506, from the retrieval unit U504 and return the phoneme data to the retrieval unit U504. The retrieval unit U504 only has to treat the returned phoneme data as a result of the retrieval.

The sound piece database creating unit U512 may read sound piece data and a phonogram string, which become materials for new compressed sound piece data to be added to the sound piece database U509, from a recording medium set in a not-shown recording medium driving device via this recording medium driving device.

The sound piece registering unit R does not always have to include the recorded sound-piece-dataset storing unit U511.

The pitch component data may be data representing a change over time of a pitch length of a sound piece represented by sound piece data. In this case, the sound piece editing unit U507 only has to specify a position where the pitch length is the shortest on the basis of the pitch component data and interpret that this position is a position of accent.

The sound piece editing unit U507 may store rhythm registration data representing a rhythm of a specific sound piece in advance and, when this specific sound piece is included in a fixed form message, treat the rhythm represented by this rhythm registration data as a result of rhythm prediction.

The sound piece editing unit U507 may store results of rhythm prediction in the past as rhythm registration data anew.

The sound piece database creating unit U512 may include a microphone, an amplifier, a sampling circuit, an A/D (Analog-to-Digital) converter, and a PCM encoder. In this case, instead of acquiring sound piece data from the recorded sound-piece-dataset storing unit 12, the sound piece database creating unit U512 may amplify a sound signal representing a sound collected by the own microphone and subject the sound signal to sampling and A/D conversion and, then, apply the PCM modulation to the sound signal subjected to sampling to thereby create sound piece data.

The sound piece editing unit U507 may supply the waveform data returned from the acoustic processing unit U503 to the speech speed converting unit 11 to thereby cause a time length of a waveform represented by the waveform data to match speed indicated by the utterance speed data.

For example, the sound piece editing unit U507 may acquire free text data with the language processing unit U501, select sound piece data representing a waveform close to a waveform of sound pieces included in a free text represented by this free text data by performing processing substantially identical with the processing for selecting sound piece data representing a waveform close to a waveform of sound pieces included in a fixed form message, and use the sound piece data for synthesis of a sound.

In this case, concerning a sound piece represented by the sound piece data selected by the sound piece editing unit U507, the acoustic processing unit U503 does not have to cause the retrieval unit 5 to retrieve phoneme data representing a waveform of this sound piece. Note that the sound piece editing unit U507 only has to notify the acoustic processing unit U503 of a sound piece, which the acoustic processing unit U503 does not have to synthesize, and the acoustic processing unit 4 only has to stop retrieval of a waveform of a unit sound constituting this sound piece in response to this notification.

For example, the sound piece editing unit U507 acquires distributed character string data with the acoustic processing unit U503, select sound piece data representing a waveform close to a waveform of sound pieces included in a distributed character string represented by this distributed character sting data by performing processing substantially identical with the processing for selecting sound piece data representing a waveform close to a waveform of sound pieces included in a fixed form message, and use the sound piece data for synthesis of a sound. In this case, concerning a sound piece represented by the sound piece data selected by the sound piece editing unit U507, the acoustic processing unit U503 does not have to cause the retrieval unit 5 to retrieve phoneme data representing a waveform of this sound piece.

Both the phoneme data supply unit T and the phoneme data using unit U are not required to be a dedicated system. Therefore, it is possible to constitute the phoneme data supply unit T, which executes the processing described above, by installing a program for causing a personal computer to execute the operations of the sound data dividing unit T1, the phoneme data compressing unit T2, and the compressed phoneme data output unit T3 from a recording medium storing the program. It is possible to constitute the phoneme data using unit U, which executes the processing described above, by installing a program for causing a personal computer to execute the operations of the compressed phoneme data input unit U1, the entropy coding/decoding unit U2, the nonlinear inverse quantization unit U3, the phoneme data restoring unit U4, and the sound synthesis unit U5 from a recording medium storing the program.

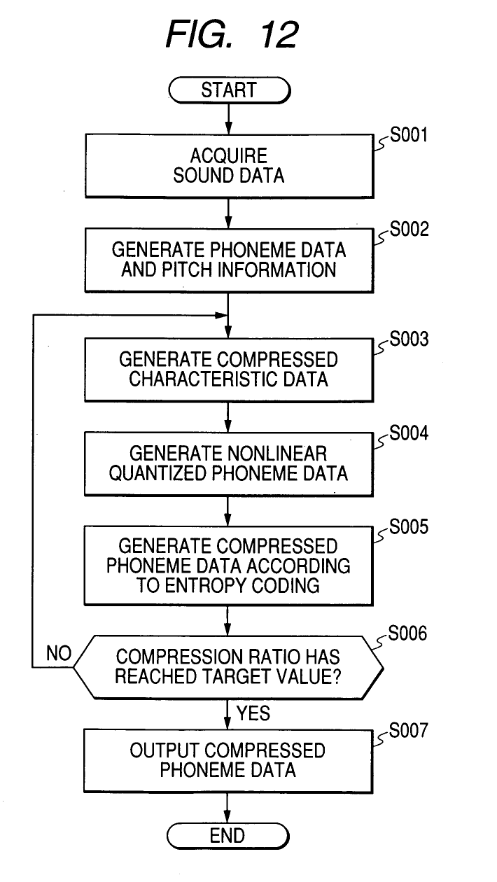

The personal computer, which executes the programs and functions as the phoneme data supply unit T, performs processing shown in FIG. 12 as processing equivalent to the operations of the phoneme data supply unit T in FIG. 8.

FIG. 12 is a flowchart showing processing of the personal computer that carries out the function of the phoneme data supply unit T.

When the personal computer carrying out the function of the phoneme data supply unit T (hereinafter referred to as phoneme data supply computer) acquires sound data representing a waveform of a sound (FIG. 12, step S001), the phoneme data supply computer performs processing substantially identical with the processing in step S2 to step S16 performed by the computer C1 in the first embodiment to thereby generate phoneme data and pitch information (step S002).

Next, the phoneme data supply computer generates the compression characteristic data described above (step S003). The phoneme data supply computer generates nonlinear quantized phoneme data equivalent to a quantized value of a value obtained by applying nonlinear compression to an instantaneous value of a waveform represented by the phoneme data generated in step S002 in accordance with this compression characteristic data (step S004). The phoneme data supply computer generates compressed phoneme data by subjecting the generated nonlinear quantized phoneme data, the pitch information generated in step S002, the compression characteristic data generated in step S003 (step S005).

Next, the phoneme data supply computer judges whether a ratio of a data amount of compressed phoneme data generated most recently in step S005 to a data amount of the phoneme data generated in step S002 (i.e., a present compression ratio) has reached a target predetermined compression ratio (step s006). When it is judged that the ratio has reached the predetermined compression ratio, the phoneme data supply computer advances the processing to step S007. When it is judged that the ratio has not reached the predetermined compression ratio, the phoneme data supply computer returns the processing to step S003.

When the processing returns from step S006 to S003, if the present compression ratio is larger than the target compression ratio, the phoneme data supply computer determines a compression characteristic such that the compression ratio becomes smaller than the present compression ratio. On the other hand, if the present compression ratio is smaller than the target compression ratio, the phoneme data supply computer determines a compression characteristic such that the compression ratio becomes larger than the present compression ratio.

On the other hand, in step S007, the phoneme data supply computer outputs compressed phoneme data generated most recently in step S005.

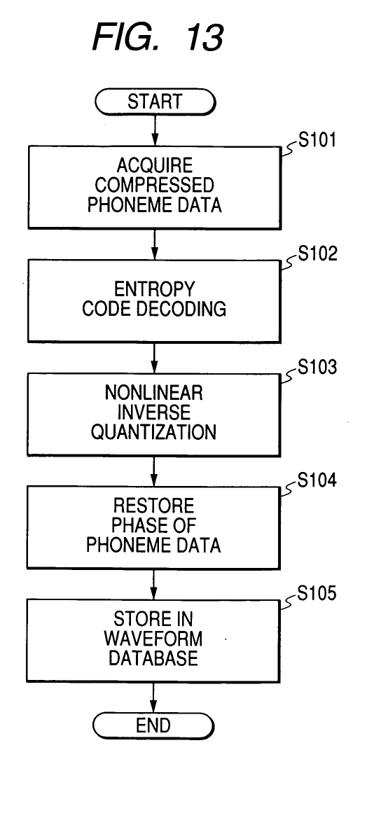

On the other hand, the personal computer executing the program and functioning as the phoneme data using unit U performs processing shown in FIG. 13 to FIG. 16 as processing equivalent to the operations of the phoneme data using unit U in FIG. 8.

FIG. 13 is a flowchart showing processing in which the personal computer carrying out the function of the phoneme data using unit acquires phoneme data.

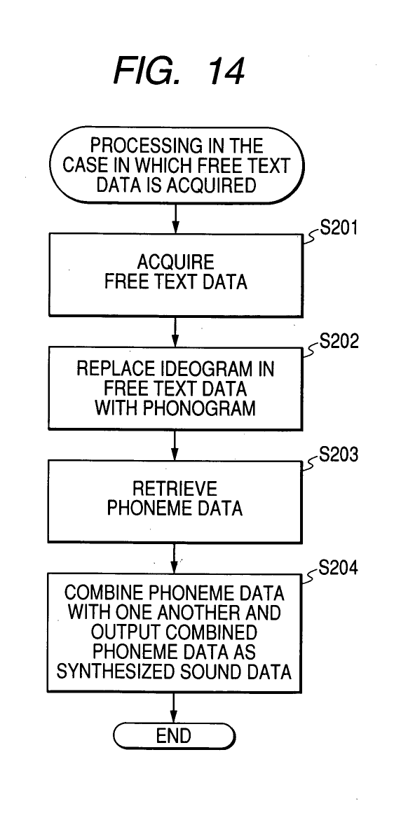

FIG. 14 is a flowchart showing processing of sound synthesis in the case in which the personal computer carrying out the function of the phoneme data using unit U acquires free text data.

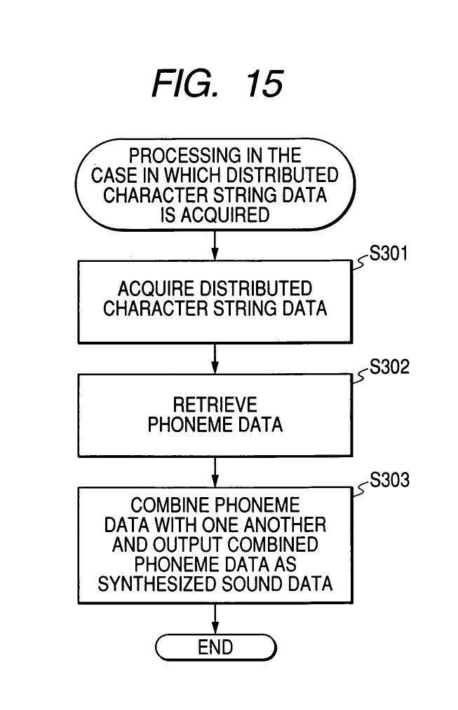

FIG. 15 is a flowchart showing processing of sound synthesis in the case in which the personal computer carrying out the function of the phoneme data using unit U acquires distributed character string data.

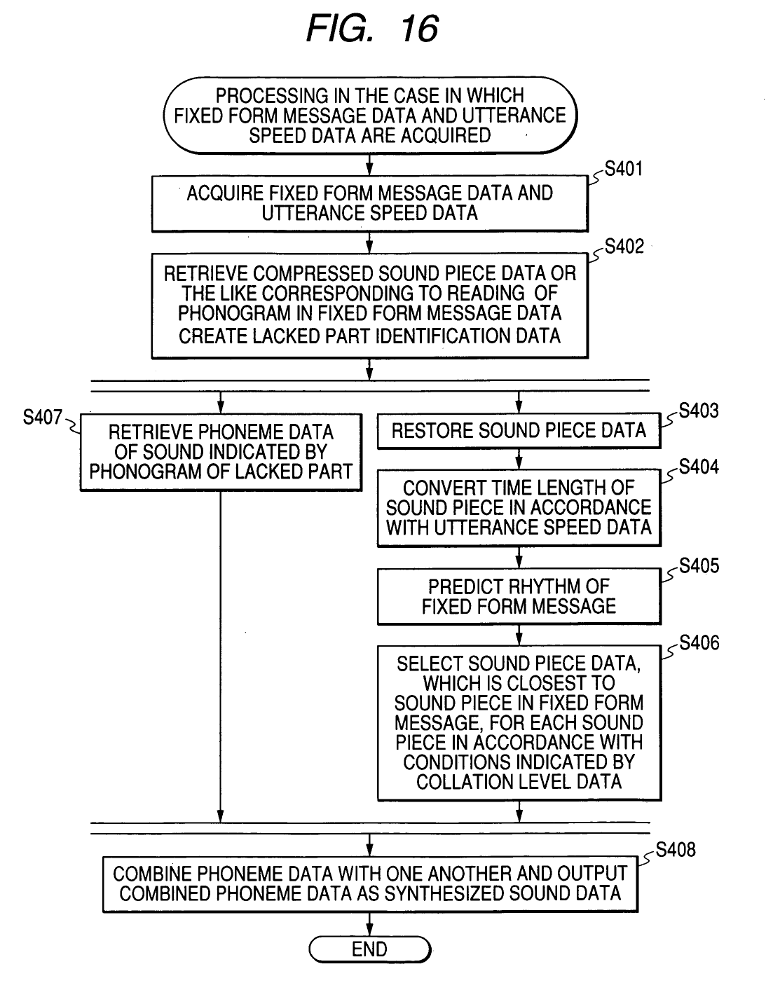

FIG. 16 is a flowchart showing processing of sound synthesis in the case in which the personal computer carrying out the function of the phoneme data using unit U acquires fixed form message data and utterance speed data.

When the personal computer carrying out the function of the phoneme data using unit U (hereinafter referred to as phoneme data using computer) acquires compressed phoneme data outputted by the phoneme data supply unit T or the like (FIG. 13, step S101), the phoneme data using computer decodes this compressed phoneme data equivalent to nonlinear quantized phoneme data, pitch information, and compression characteristic data subjected to the entropy coding to thereby restore the nonlinear quantized phoneme data, the pitch information, and the compressed characteristic data (step S102).

Next, the phoneme data using computer changes an instantaneous value of a waveform represented by the restore nonlinear quantized phoneme data in accordance with a characteristic in a relation of inverse conversion with a compression characteristic indicted by this compression characteristic data to thereby restore phoneme data before being subjected to nonlinear quantization (step S103).

Next, the phoneme data using computer changes time lengths of respective sections of the phoneme data restored in step S103 to be a time length indicated by the pitch information restored in step S102 (step S104).

The phoneme data using computer stores the phoneme data with the time lengths of the respective sections changed, that is, the restored phoneme data in the waveform database U506 (step s105).

When the phoneme data using computer acquires the free text data from the outside (FIG. 14, step S201), for each of ideograms included in a free text represented by this free text data, the phoneme data using computer specifies a phonogram representing reading of the ideogram by searching through a general word dictionary 2 and a user word dictionary 3 and replaces this ideogram with the specified phonogram (step S202). Note that a method with which the phoneme data using computer acquires free text data is arbitrary.

When a phonogram string representing a result of replacing all ideograms in the free text with phonograms is obtained, for each of phonograms included in this phonogram string, the phoneme data using computer retrieves a waveform of a unit sound represented by the phonogram from the waveform database 7 and retrieves phoneme data representing a waveform of a unit sound represented by each of the phonograms included in the phonogram string (step S203).

The phoneme data using computer combines the retrieved phoneme data with one another in an order complying with arrangement of the respective phonograms in the phonogram string and outputs the combined phoneme data as synthesized sound data (step S204). Note that a method with which the phoneme data using computer outputs synthesized sound data is arbitrary.

When the phoneme data using computer acquires the distributed character string data described above from the outside (FIG. 15, step s301), for each of phonograms included in a phonogram string represented by this distributed character string data, the phoneme data using computer retrieves a waveform of a unit sound represented by the phonogram from the waveform database 7 and retrieves phoneme data representing a waveform of a unit sound represented by each of the phonograms included in the phonogram string (step S302).

The phoneme data using computer combines the retrieved phoneme data with one another in an order complying with arrangement of the respective phonograms in the phonogram string and outputs the combined phoneme data as synthesized sound data with processing same as the processing in step S204 (step S303).

On the other hand, when the phoneme data using computer acquires the fixed form message data and the utterance speed data described above from the outside with an arbitrary method (FIG. 16, step S401), the phoneme data using computer retrieves all compressed sound piece data to which phonograms matching phonograms representing reading of sound pieces included in a fixed form message represented by this fixed form message data are associated (step S402).

In step S402, the phoneme data using computer also retrieves the sound piece reading data, the speed initial value data, and the pitch component data associated with corresponding compressed sound piece data. Note that, when plural compressed sound piece data correspond to one sound piece, the phoneme data using computer retrieves all corresponding compressed sound piece data. On the other hand, when there is a sound piece for which compressed sound piece data cannot be retrieved, the phoneme data using computer generates the lacked part identification data described above.

Next, the phoneme data using computer restores the retrieved compressed sound piece data to sound piece data before being compressed (step S403). The phoneme data using computer converts the restored sound piece data with processing same as the processing performed by the sound piece editing unit 8 to cause a time length of a sound piece represented by the sound piece data to match speed indicated by the utterance speed data (step. S404). Note that, when the utterance speed data is not supplied, the phoneme data using computer does not have to convert the restored sound piece data.

Next, the phoneme data using computer applies analysis based on the method of rhythm prediction to the fixed form message represented by the fixed form message data to thereby predict a rhythm of this fixed form message (step S405). The phoneme data using computer selects one sound piece data representing a waveform, which is closest to a waveform of sound pieces constituting the fixed form message, for one sound piece out of the sound piece data, time lengths of sound pieces of which are converted, in accordance with a standard indicated by the collation level data acquired from the outside by performing processing same as the processing performed by the sound piece editing unit 8 (step S406).

Specifically, in step S406, the phoneme data using computer specifies sound piece data in accordance with, for example, the conditions (1) to (3) described above. When a value of the collation level data is “1”, the phoneme data using computer regards that all sound piece data, reading of which matches sound pieces in the fixed form message, represent a waveform of the sound pieces in the fixed form message. When a value of the collation level data is “2”, only when phonograms representing reading match and contents of pitch component data representing a change over time of a frequency of a pitch component of the sound piece data match a result of prediction of accent of the sound pieces included in the fixed form message, the phoneme data using computer regards that this sound piece data represents the waveform of the sound pieces in the fixed form message. When a value of the collation level data is “3”, only when phonograms and accent representing reading match and presence or absence of the change of a sound represented by the sound piece data to a nosal voice or silence matches a result of prediction of a rhythm of the fixed form message, the phoneme data using computer regards that this sound piece data represents the waveform of the sound pieces in the fixed form message.

Note that, when there are plural sound piece data matching a standard indicated by the collation level data for one sound piece, the phoneme data using computer narrows down these plural sound piece data to one sound piece data in accordance with a condition more strict than the set condition.

On the other hand, when the lacked part identification data is generated, the phoneme data using computer extracts a phonogram string representing reading of a sound piece indicated by the lacked part identification data from the fixed form message data. The phoneme data using computer treats this phonogram string in the same manner as the phonogram string represented by the distributed character string data to apply the processing in step S302 to each phoneme to thereby retrieve phoneme data representing a waveform of a sound indicated by the respective phonograms in this phonogram string (step S407).

The phoneme data using computer combines the retrieved phoneme data and the sound piece data selected in step S406 with each other in an order complying with arrangement of the respective sound pieces in the fixed form message indicted by the fixed form message and outputs the combined data as data representing a synthesized sound (step S408).

Note that programs for causing a personal computer to carry out the functions of the body unit M and the sound piece registering unit R may be, for example, uploaded to a bulletin board system (BBS) on a communication line and distributed through the communication line. It is also possible that a carrier wave is modulated by signals representing these programs, an obtained modulated wave is transmitted, and an apparatus having received this modulated wave demodulates the modulated wave to restore the programs.

It is possible to execute the processing described above by starting the programs and executed in the same manner as other application programs under the control of an OS.

Note that when the OS carries out a part of the processing or the OS constitutes a part of one element of the invention, a program excluding the part may be stored in a recording medium. In this case, in the invention, it is also assumed that respective functions executed by a computer or programs for executing steps are stored in the recording medium.

1. A pitch waveform signal division device comprising:
a filter for acquiring a sound signal representing a waveform of sound and filtering the sound signal to extract a pitch signal;
phase adjusting means for delimiting the sound signal into sections based on the pitch signal extracted by the filter and adjusting the phase for each section based on the correlation between the section and the pitch signal;
sampling means for determining a sampling length for each section with the phase adjusted by the phase adjusting means, based on the phase, and performing sampling with the sampling length to generate a sampling signal;
sound signal processing means for processing the sampling signal into a pitch waveform signal based on the result of the adjustment by the phase adjusting means and the value of the sampling length; and
pitch waveform signal dividing means for detecting a boundary of adjacent phonemes included in the sound represented by the pitch waveform signal and/or an end of the sound, and dividing the pitch waveform signal at the detected boundary and/or end.

2. The pitch waveform signal division device according to claim 1, wherein the pitch waveform signal dividing means determines whether the intensity of the difference between two adjacent sections for a unit pitch of the pitch waveform signal is a predetermined amount or more, and if it is determined to be the predetermined amount or more, then it detects the boundary between the two sections as a boundary of adjacent phonemes or an end of sound.

3. The pitch waveform signal division device according to claim 2, wherein the pitch waveform signal dividing means determines whether the two sections represent fricative based on the intensity of a portion of the pitch signal belonging to the two sections, and if it is determined that they represent fricative, then it determines that the boundary of the two sections is not a boundary of adjacent phonemes or an end of sound regardless of whether the intensity of the difference between the two sections is the predetermined amount or more.

4. The pitch waveform signal division device according to claim 2, wherein the pitch waveform signal dividing means determines whether a portion of the pitch signal belonging to the two sections is a predetermined amount or less, and if it is determined to be the amount or less, then it determines that the boundary of the two sections is not a boundary of adjacent phonemes or an end of sound regardless of whether the intensity of the difference between the two sections is the predetermined amount or more.

5. A pitch waveform signal division device comprising:
sound signal processing means for acquiring a sound signal representing a waveform of sound, and processing the sound signal into a pitch waveform signal by substantially equalizing the phases of sections where the sound signal is divided into the sections for a unit pitch of the sound; and
pitch waveform signal dividing means for detecting a boundary of adjacent phonemes included in the sound represented by the pitch waveform signal and/or an end of the sound, and dividing the pitch waveform signal at the detected boundary and/or end.

6. A pitch waveform signal division device comprising:
means for detecting, for pitch waveform signal representing a waveform of sound, a boundary of adjacent phonemes included in the sound represented by the pitch waveform signal and/or an end of the sound; and
means for dividing the pitch waveform signal at the detected boundary and/or end.

7. A sound signal compression device comprising:
a filter for acquiring a sound signal representing a waveform of sound and filtering the sound signal to extract a pitch signal;
phase adjusting means for delimiting the sound signal into sections based on the pitch signal extracted by the filter and adjusting the phase for each section based on the correlation between the section and the pitch signal;
sampling means for determining a sampling length for each section with the phase adjusted by the phase adjusting means, based on the phase, and performing sampling with the sampling length to generate a sampling signal;
sound signal processing means for processing the sampling signal into a pitch waveform signal based on the result of the adjustment by the phase adjusting means and the value of the sampling length;
phoneme data generating means for detecting a boundary of adjacent phonemes included in the sound represented by the pitch waveform signal and/or an end of the sound, and dividing the pitch waveform signal at the detected boundary and/or end to generate phoneme data; and
data compressing means for subjecting the generated phoneme data to entropy coding to perform data compression.

8. The sound signal compression device according to claim 7, wherein the pitch waveform signal dividing means determines whether the intensity of the difference between two adjacent sections for a unit pitch of the pitch waveform signal is a predetermined amount or more, and if it is determined to be the predetermined amount or more, then it detects the boundary between the two sections as a boundary of an adjacent phonemes or an end of sound.

9. The sound signal compression device according to claim 8, wherein the pitch waveform signal dividing means determines whether the two sections represent fricative based on the intensity of a portion of the pitch signal belonging to the two sections, and if it is determined that they represent fricative, then it determines that the boundary of the two sections is not a boundary of adjacent phonemes or an end of sound regardless of whether the intensity of the difference between the two sections is the predetermined amount or more.

10. The sound signal compression device according to claim 8, wherein the pitch waveform signal dividing means determines whether a portion of the pitch signal belonging to the two sections is a predetermined amount or less, and if it is determined to be the amount or less, then it determines that the boundary of the two sections is not a boundary of adjacent phonemes or an end of sound regardless of whether the intensity of the difference between the two sections is the predetermined amount or more.

11. A sound signal compression device comprising:
sound signal processing means for acquiring a sound signal representing a waveform of sound, and processing the sound signal into a pitch waveform signal by substantially equalizing the phases of sections where the sound signal is divided into the sections for a unit pitch of the sound;
phoneme data generating means for detecting a boundary of adjacent phonemes included in the sound represented by the pitch waveform signal and/or an end of the sound, and dividing the pitch waveform signal at the detected boundary and/or end to generate phoneme data; and
data compressing means for subjecting the generated phoneme data to entropy coding to perform data compression.

12. A sound signal compression device comprising:
means for detecting, for pitch waveform signal representing a waveform of sound, a boundary of adjacent phonemes included in the sound represented by the pitch waveform signal and/or an end of the sound;
phoneme data generating means for dividing the pitch waveform signal at the detected boundary and/or end to generate phoneme data; and
data compressing means for subjecting the generated phoneme data to entropy coding to perform data compression.

13.-16. (canceled)

17. A database for storing phoneme data, wherein the phoneme data is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound.

18. A database for storing phoneme data, wherein the phoneme data is acquired by dividing a pitch waveform signal representing a waveform of sound at a boundary of adjacent phonemes included in the sound represented by the pitch waveform signal and/or end of the sound.

19.-20. (canceled)

21. A computer readable recording medium for storing phoneme data, wherein the phoneme data is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound.

22. A computer readable recording medium for storing phoneme data, wherein the phoneme data is acquired by dividing a pitch waveform signal representing a waveform of sound at a boundary of adjacent phonemes included in the sound represented by the pitch waveform signal and/or end of the sound.

23.-24. (canceled)

25. A sound signal restoration device comprising:
data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound; and
restoring means for decoding the acquired phoneme data.

26.-29. (canceled)

30. A sound synthesis device comprising:
data acquiring means for acquiring phoneme data which is acquired by dividing a pitch waveform signal at a boundary of adjacent phonemes included in the sound represented by the pitch waveform signal and end of the sound, the pitch waveform signal being acquired by substantially equalizing the phases of sections where the sound signal representing a waveform of sound is divided into the sections for a unit pitch of the sound;
restoring means for decoding the acquired phoneme data;
phoneme data storing means for storing the acquired phoneme data or the decoded phoneme data;
sentence input means for inputting sentence information representing a sentence; and
synthesizing means for retrieving from the phoneme data storing means, phoneme data representing waveforms of phonemes composing the sentence, and combining the retrieved phoneme data pieces to generate data representing synthesized sound.

31. The sound synthesis device according to claim 30, further comprising:
sound piece storing means for phoneme data pieces representing sound pieces;
rhythm predicting means for predicting a rhythm of a sound piece composing an inputted sentence; and
selecting means for selecting from the sound data pieces, sound data that represents a waveform of a sound piece having the same reading as a sound piece composing the sentence and has a rhythm closest to the prediction result, wherein the synthesizing means comprises
lacked part synthesizing means for retrieving from the phoneme data storing means, for a sound piece of which sound data has not been selectable by the selecting means among the sound pieces composing the sentence, phoneme data representing a waveform of phonemes composing the sound piece having not been selectable, and combining the retrieved phoneme data pieces to synthesize data representing the sound piece having not been selectable, and
means for generating data representing synthesized sound by combining the sound data selected by the selecting means and the sound data synthesized by the lacked part synthesizing means.

32. The sound synthesis device according to claim 31, wherein the sound piece storing means stores actual measured rhythm data representing temporal change in pitch of the sound piece represented by sound data, in correspondence with the sound data, and
the selecting means selects from the sound data pieces, sound data which represents a waveform having the same reading as a sound piece composing the sentence, the temporal change in pitch represented by the actual measured rhythm data in correspondence with the sound data being closest to the prediction result of rhythm.

33.-35. (canceled)

36. A pitch waveform signal division method comprising:
acquiring a sound signal representing a waveform of sound and filtering the sound signal to extract a pitch signal;
delimiting the sound signal into sections based on the extracted pitch signal and adjusting the phase for each section based on the correlation between the section and the pitch signal;
determining a sampling length for each section with the adjusted phase based on the phase, and performing sampling with the sampling length to generate a sampling signal;
processing the sampling signal into a pitch waveform signal based on the result of the adjustment by the phase adjusting means and the value of the sampling length; and
detecting a boundary of adjacent phonemes included in the sound represented by the pitch waveform signal and/or an end of the sound, and dividing the pitch waveform signal at the detected boundary and/or end.

37. A pitch waveform signal division method comprising:
acquiring a sound signal representing a waveform of sound, and processing the sound signal into a pitch waveform signal by substantially equalizing the phases of sections where the sound signal is divided into the sections for a unit pitch of the sound; and
detecting a boundary of adjacent phonemes included in the sound represented by the pitch waveform signal and/or an end of the sound, and dividing the pitch waveform signal at the detected boundary and/or end.

38. A pitch waveform signal division method comprising:
detecting, for pitch waveform signal representing a waveform of sound, a boundary of adjacent phonemes included in the sound represented by the pitch waveform signal and/or an end of the sound; and
dividing the pitch waveform signal at the detected boundary and/or end.

39. A sound signal compression method comprising:
acquiring a sound signal representing a waveform of sound and filtering the sound signal to extract a pitch signal;
delimiting the sound signal into sections based on the pitch signal extracted by the filter and adjusting the phase for each section based on the correlation between the section and the pitch signal;
determining a sampling length for each section with the adjusted phase based on the phase, and performing sampling with the sampling length to generate a sampling signal;
processing the sampling signal into a pitch waveform signal based on the result of the adjustment of the phase and the value of the sampling length;
detecting a boundary of adjacent phonemes included in the sound represented by the pitch waveform signal and/or an end of the sound, and dividing the pitch waveform signal at the detected boundary and/or end to generate phoneme data; and
subjecting the generated phoneme data to entropy coding to perform data compression.

40. A sound signal compression method comprising:
acquiring a sound signal representing a waveform of sound, and processing the sound signal into a pitch waveform signal by substantially equalizing the phases of sections where the sound signal is divided into the sections for a unit pitch of the sound;
detecting a boundary of adjacent phonemes included in the sound represented by the pitch waveform signal and/or an end of the sound, and dividing the pitch waveform signal at the detected boundary and/or end to generate phoneme data; and
subjecting the generated phoneme data to entropy coding to perform data compression.

41. A sound signal compression method comprising:
detecting, for pitch waveform signal representing a waveform of sound, a boundary of adjacent phonemes included in the sound represented by the pitch waveform signal and/or an end of the sound;
dividing the pitch waveform signal at the detected boundary and/or end to generate phoneme data; and
subjecting the generated phoneme data to entropy coding to perform data compression.

42. A sound signal restoration method comprising:
acquiring phoneme data which is acquired by dividing a pitch waveform signal at a boundary of adjacent phonemes included in the sound represented by the pitch waveform signal and end of the sound, the pitch waveform signal being acquired by substantially equalizing the phases of sections where the sound signal representing a waveform of sound is divided into the sections for a unit pitch of the sound; and
decoding the acquired phoneme data.

43. A sound synthesis method comprising:
acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound;
restoring the phase of the acquired phoneme data to the phase before the process;
storing the acquired phoneme data or the phoneme data with the restored phase;
inputting sentence information representing a sentence; and
retrieving phoneme data representing waveforms of phonemes composing the sentence from the stored phoneme data, and combining the retrieved phoneme data pieces to generate data representing synthesized sound.

44. A program for making a computer act as:
a filter for acquiring a sound signal representing a waveform of sound and filtering the sound signal to extract a pitch signal;
phase adjusting means for delimiting the sound signal into sections based on the pitch signal extracted by the filter and adjusting the phase for each section based on the correlation between the section and the pitch signal;
sampling means for determining a sampling length for each section with the phase adjusted by the phase adjusting means, based on the phase, and performing sampling with the sampling length to generate a sampling signal;
sound signal processing means for processing the sampling signal into a pitch waveform signal based on the result of the adjustment by the phase adjusting means and the value of the sampling length; and
pitch waveform signal dividing means for detecting a boundary of adjacent phonemes included in the sound represented by the pitch waveform signal and/or an end of the sound, and dividing the pitch waveform signal at the detected boundary and/or end.

45. A program for making a computer act as:
sound signal processing means for acquiring a sound signal representing a waveform of sound, and processing the sound signal into a pitch waveform signal by substantially equalizing the phases of sections where the sound signal is divided into the sections for a unit pitch of the sound; and
pitch waveform signal dividing means for detecting a boundary of adjacent phonemes included in the sound represented by the pitch waveform signal and an end of the sound, and dividing the pitch waveform signal at the detected boundary and end.

46. A program for making a computer act as:
means for detecting, for pitch waveform signal representing a waveform of sound, a boundary of adjacent phonemes included in the sound represented by the pitch waveform signal and/or an end of the sound; and
means for dividing the pitch waveform signal at the detected boundary and/or end.

47. A program for making a computer act as:
a filter for acquiring a sound signal representing a waveform of sound and filtering the sound signal to extract a pitch signal;
phase adjusting means for delimiting the sound signal into sections based on the pitch signal extracted by the filter and adjusting the phase for each section based on the correlation between the section and the pitch signal;
sampling means for determining a sampling length for each section with the phase adjusted by the phase adjusting means, based on the phase, and performing sampling with the sampling length to generate a sampling signal;
sound signal processing means for processing the sampling signal into a pitch waveform signal based on the result of the adjustment by the phase adjusting means and the value of the sampling length;
phoneme data generating means for detecting a boundary of adjacent phonemes included in the sound represented by the pitch waveform signal and/or an end of the sound, and dividing the pitch waveform signal at the detected boundary and/or end to generate phoneme data; and
data compressing means for subjecting the generated phoneme data to entropy coding to perform data compression.

48. A program for making a computer act as:
sound signal processing means for acquiring a sound signal representing a waveform of sound, and processing the sound signal into a pitch waveform signal by substantially equalizing the phases of sections where the sound signal is divided into the sections for a unit pitch of the sound;
phoneme data generating means for detecting a boundary of adjacent phonemes included in the sound represented by the pitch waveform signal and/or an end of the sound, and dividing the pitch waveform signal at the detected boundary and/or end to generate phoneme data; and
data compressing means for subjecting the generated phoneme data to entropy coding to perform data compression.

49. A program for making a computer act as:
means for detecting, for pitch waveform signal representing a waveform of sound, a boundary of adjacent phonemes included in the sound represented by the pitch waveform signal and/or an end of the sound;
phoneme data generating means for dividing the pitch waveform signal at the detected boundary and/or end to generate phoneme data; and
data compressing means for subjecting the generated phoneme data to entropy coding to perform data compression.

50. A program for making a computer act as:
data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound; and
restoring means for decoding the acquired phoneme data.

51. A program for making a computer act as:
data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound;
restoring means for decoding the acquired phoneme data;
phoneme data storing means for storing the acquired phoneme data or the decoded phoneme data;
sentence input means for inputting sentence information representing a sentence; and
synthesizing means for retrieving from the phoneme data storing means, phoneme data representing waveforms of phonemes composing the sentence, and combining the retrieved phoneme data pieces to generate data representing synthesized sound.

52. A computer readable recording medium having a program recorded thereon for making a computer act as:
a filter for acquiring a sound signal representing a waveform of sound and filtering the sound signal to extract a pitch signal;
phase adjusting means for delimiting the sound signal into sections based on the pitch signal extracted by the filter and adjusting the phase for each section based on the correlation between the section and the pitch signal;
sampling means for determining a sampling length for each section with the phase adjusted by the phase adjusting means, based on the phase, and performing sampling with the sampling length to generate a sampling signal;
sound signal processing means for processing the sampling signal into a pitch waveform signal based on the result of the adjustment by the phase adjusting means and the value of the sampling length; and
pitch waveform signal dividing means for detecting a boundary of adjacent phonemes included in the sound represented by the pitch waveform signal and/or an end of the sound, and dividing the pitch waveform signal at the detected boundary and/or end.

53. A computer readable recording medium having a program recorded thereon for making a computer act as:
sound signal processing means for acquiring a sound signal representing a waveform of sound, and processing the sound signal into a pitch waveform signal by substantially equalizing the phases of sections where the sound signal is divided into the sections for a unit pitch of the sound; and
pitch waveform signal dividing means for detecting a boundary of adjacent phonemes included in the sound represented by the pitch waveform signal and/or an end of the sound, and dividing the pitch waveform signal at the detected boundary and/or end.

54. A computer readable recording medium having a program recorded thereon for making a computer act as:
means for detecting, for pitch waveform signal representing a waveform of sound, a boundary of adjacent phonemes included in the sound represented by the pitch waveform signal and/or an end of the sound; and
means for dividing the pitch waveform signal at the detected boundary and/or end.

55. A computer readable recording medium having a program recorded thereon for making a computer act as:
a filter for acquiring a sound signal representing a waveform of sound and filtering the sound signal to extract a pitch signal;
phase adjusting means for delimiting the sound signal into sections based on the pitch signal extracted by the filter and adjusting the phase for each section based on the correlation between the section and the pitch signal;
sampling means for determining a sampling length for each section with the phase adjusted by the phase adjusting means, based on the phase, and performing sampling with the sampling length to generate a sampling signal;
sound signal processing means for processing the sampling signal into a pitch waveform signal based on the result of the adjustment by the phase adjusting means and the value of the sampling length;
phoneme data generating means for detecting a boundary of adjacent phonemes included in the sound represented by the pitch waveform signal and/or an end of the sound, and dividing the pitch waveform signal at the detected boundary and/or end to generate phoneme data; and
data compressing means for subjecting the generated phoneme data to entropy coding to perform data compression.

56. A computer readable recording medium having a program recorded thereon for making a computer act as:
sound signal processing means for acquiring a sound signal representing a waveform of sound, and processing the sound signal into a pitch waveform signal by substantially equalizing the phases of sections where the sound signal is divided into the sections for a unit pitch of the sound;
phoneme data generating means for detecting a boundary of adjacent phonemes included in the sound represented by the pitch waveform signal and/or an end of the sound, and dividing the pitch waveform signal at the detected boundary and/or end to generate phoneme data; and
data compressing means for subjecting the generated phoneme data to entropy coding to perform data compression.

57. A computer readable recording medium having a program recorded thereon for making a computer act as:
means for detecting, for pitch waveform signal representing a waveform of sound, a boundary of adjacent phonemes included in the sound represented by the pitch waveform signal and/or an end of the sound;
phoneme data generating means for dividing the pitch waveform signal at the detected boundary and/or end to generate phoneme data; and
data compressing means for subjecting the generated phoneme data to entropy coding to perform data compression.

58. A computer readable recording medium having a program recorded thereon for making a computer act as:
data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound; and
restoring means for decoding the acquired phoneme data.

59. A computer readable recording medium having a program recorded thereon for making a computer act as:
data acquiring means for acquiring phoneme data which is acquired by dividing a pitch waveform signal at a boundary of adjacent phonemes included in the sound represented by the pitch waveform signal and/or end of the sound, the pitch waveform signal being acquired by substantially equalizing the phases of sections where the sound signal representing a waveform of sound is divided into the sections for a unit pitch of the sound;
restoring means for restoring the phase of the acquired phoneme data to the phase before the process;
phoneme data storing means for storing the acquired phoneme data or the phoneme data with the restored phase;
sentence input means for inputting sentence information representing a sentence; and
synthesizing means for retrieving from the phoneme data storing means, phoneme data representing waveforms of phonemes composing the sentence, and combining the retrieved phoneme data pieces to generate data representing synthesized sound.
